(19) United States
(12) Patent Application Publication
(10) Pub. No.: US 2015/0332022 A9
(43) Pub. Date: Nov. 19, 2015

(54) METHOD AND APPARATUS FOR ADMINISTERING CLINICAL TRIALS

(71) Applicants: Zikria Qayoom Syed, Malvern, PA (US); Matthew John Walz, Wilmington, DE (US); Jeffrey Scott Burk, Chester Springs, PA (US); Chester Joseph Shemanski, Collegeville, PA (US)

(72) Inventors: Zikria Qayoom Syed, Malvern, PA (US); Matthew John Walz, Wilmington, DE (US); Jeffrey Scott Burk, Chester Springs, PA (US); Chester Joseph Shemanski, Collegeville, PA (US)

(73) Assignee: NEXTDOCS CORPORATION, King of Prussia, PA (US)

(21) Appl. No.: 13/081,818

(22) Filed: Apr. 7, 2011

Related U.S. Application Data
(60) Provisional application No. 61/341,951, filed on Apr. 7, 2010.

(51) Int. Cl. G06Q 50/00; G06Q 10/00

(52) U.S. Cl. CPC G06F 19/366

(57) ABSTRACT

A system and method for administering a clinical trial centralizes all trial communications in a website system. The system enables a trial sponsor to create individual websites for each of its available trials using website templates driven by workflow management software. The prospective clinical investigator can browse current and upcoming clinical trials and select trials that he/she wants to participate in. The clinical investigator can register interest in the trial by entering their contact information and professional credentials to create a personal profile. The trial sponsor can search for prospective clinical investigators whose credentials are commensurate with those required for a clinical trial. The trial sponsor also can invite prospective clinical investigators to participate in clinical trials. The system programmatically creates a secure account the clinical investigator can use to access the clinical trial website (called a collaboration portal). Once the clinical investigator logs into the collaboration portal, he/she is able to appoint sub-investigators and additional administrative accounts for the portal. The clinical investigator also uploads essential trial documentation via the collaboration portal into the document repository that the trial sponsor set up for the clinical trial. The investigator portal also gives the principal investigator a central place to access clinical trial alerts, notifications and a to-do list.

### CROSS-REFERENCE TO RELATED APPLICATIONS

The present application claims priority to U.S. provisional patent application No. 61/341,451, filed Apr. 7, 2010. The contents of that patent application are hereby incorporated by reference.

### TECHNICAL FIELD

This invention relates to a method and apparatus for clinical trial management and, in particular, to a web based system in which a clinical trial portal is created for each clinical trial and access to the portal and clinical trial documents is centrally managed.

### BACKGROUND

Drug companies (called trial sponsors) conduct clinical trials to get their drugs approved. To get approved, trial sponsors enlist hospitals, clinics, and medical schools (called investigational sites) and credentialed medical professionals (called clinical investigators) to participate in trials of drugs under development. During this trial, the trial sponsor and the investigational site exchange a large amount of data and information. Before this invention, the data was exchanged using a combination of mail, telephone, fax, email, and websites. Because such a diverse set of communication technologies were used, the trials were cumbersome to administer and involved a lot of overhead work for the principal investigator, the investigational site, and the trial sponsor.

A method and apparatus for improving the communications amongst the trial sponsors, investigational sites, and clinical investigators is desired to minimize the overhead associated with conducting clinical trials. The present invention has been developed to address this need in the art.

### SUMMARY

The current invention addresses the above-mentioned need to easily administer a clinical trial by centralizing all trial communications in a website system. Using the system of the invention, the trial sponsor can easily create individual websites for each of its available trials using website templates driven by workflow management software. The prospective clinical investigator can browse current and upcoming clinical trials and select trials that he/she wants to participate in. The clinical investigator can register interest in the trial by entering their contact information and professional credentials to create a personal profile. The trial sponsor can search for prospective clinical investigators whose credentials are commensurate with those required for a clinical trial. The trial sponsor also can invite prospective clinical investigators to participate in clinical trials. The invention programmatically creates a secure account the clinical investigator can use to access the clinical trial website (called a collaboration portal). Once the clinical investigator logs into the collaboration portal, he/she is able to appoint sub-investigators and additional administrative accounts for the portal. The clinical investigator also uploads essential trial documentation via the collaboration portal into the document repository that the trial sponsor set up for the clinical trial. The investigator portal further gives the principal investigator a central place to access clinical trial alerts, notifications and a to-do list.

In an exemplary embodiment, the invention is directed to a system and associated method for administering clinical trials. The system includes at least one processor and at least one memory storing instructions that when executed by the at least one processor cause the at least one processor to generate an administrator portal that enables a clinical trials administrator to create and manage at least one clinical trial website and to exchange clinical trial documents with the clinical trial website. A clinical trial website is generated for each clinical trial to be administered, each clinical trial website exchanging clinical trial documents with the administrator portal and each clinical trial web site having separate files for storing data supporting the associated clinical trial that is accessible by an administrator of the associated clinical trial and each authorized clinical investigator. The investigator accesses the clinical trial website through an investigator portal for each clinical investigator, the investigator portal enabling the clinical investigator to upload documents related to a clinical trial to the separate files of the associated clinical trial website to which the investigator is authorized to participate. The investigator portal also enables the investigator to monitor activities and communications related to the clinical trial to which the investigator is authorized to participate.

The administrator portal is constructed to list a plurality of investigators and enables the administrator to communicate an invitation to an investigator inviting the investigator to participate in a clinical trial. The administrator portal is also constructed to enable the administrator to create a clinical trial master file, based on a template, for an associated clinical trial website for customization to that clinical trial. Workflow management software may be used to present the templates according to an order and sequence of a predetermined workflow.

The investigator portal is constructed to list a plurality of clinical trials being administered by the administrator and to enable the investigator to communicate interest in participating in a particular clinical trial to the administrator. The investigator portal further enables an investigator to define a personal profile or a site profile for access by the administrator and to access product files relating to characteristics of the product being tested in the clinical trial. The investigator portal also enables the investigator to index uploaded documents with identifying metadata based on their identity and associated clinical trial and investigational site information and enables the investigator to access current versions of essential documents that govern the conduct of the clinical trial in real-time. The communications also may include communications relating to a to do list of required work items that are communicated between the administrator and the investigator. Safety reports related to the products under investigation may also be communicated between the administrator and the investigator.

### BRIEF DESCRIPTION OF THE DRAWINGS

The above and other features and advantages of the invention will be apparent from the following detailed description of the figures, of which:

FIG. 1 shows the architecture of a collaborative clinical trials system in accordance with the invention.

FIG. 2 shows a hardware configuration for implementing the collaborative clinical trials system of the invention.

FIG. 3 shows the Clinical Document Exchange (CDE) portal.

FIG. 4a shows the menu used to set up a new clinical trial website.

FIG. 4b shows the window that appears when the trial sponsor selects the link in FIG. 4a for requesting a new clinical trial website prompting the trial sponsor to enter the relevant information for the clinical trial.

FIG. 5 shows an exemplary clinical trial portal.

FIG. 6 shows the process for customizing the documents from the Trial Master File to become trial specific.

FIG. 7 shows how a trial specific document is edited and approved.

FIG. 8a shows the menu used to create a new investigational site.

FIG. 8b shows the window that appears when the trial sponsor selects the “Create New Investigational Site” link in FIG. 8a prompting the trial sponsor to answer a series of questions.

FIG. 9 shows the view of the Trial Site Library from the trial sponsor's perspective.

FIG. 10a shows the Investigator Portal view of the Trial Site Library.

FIG. 10b shows the Investigator portal with the adverse events documents folder's hierarchy exposed.

FIG. 11 shows the dropdown menu that trial sponsor personnel can use to create a new document.

FIG. 12 shows the first screen of the new document wizard.

FIG. 13 shows a screen that the user sees upon selecting “Upload from File” in FIG. 12 prompting the user to enter the file name.

FIG. 14 shows a window displayed after selecting the “Next” button in FIG. 13.

FIG. 15 shows the window prompting the principal investigator to insert the product name, study number and the dosage.

FIG. 16 shows the confirmation panel for the document.

FIG. 17 shows a representation of a sample logical data model for the key lists that are included in the clinical module.

FIG. 18 shows a standard SharePoint list processing form for creation of a new Clinical Trial list item or editing an existing list item.

FIG. 19 shows a standard SharePoint list processing form for creation of a new Investigational Site list item or editing an existing list item.

FIG. 20 shows a standard SharePoint list processing form for creation of a new Site Personnel list item or editing an existing list item.

FIG. 21 shows a form only available at the clinical trial sub-site and used to build the Investigational Site list at that sub-site.

FIG. 22 shows a form only available at the clinical trial sub-site and used to add existing Investigational Sites to the clinical trial at that sub-site.

FIG. 23 shows a form only available at the clinical trial sub-site and used to build the Site Personnel list at that sub-site.

FIG. 24 shows a form only available at the clinical trial sub-site and used to add existing Site Personnel list to the clinical trial at that sub-site.

FIG. 25 shows the login page as seen by the external user.

FIG. 26 shows the user registration page that is shown to an external user.

FIG. 27 shows the Central Administration site for configuring the Secure Extranet Access feature of the invention.

FIG. 28 shows the SharePoint Web application structure used by the collaboration portal in an exemplary embodiment.

FIG. 29 shows a sponsor's clinical trials listed on a Clinical Trials page.

FIG. 30 shows a Register Interest page where one may register his/her interest in participating in a clinical trial.

FIG. 31 shows the whole External View website.

FIG. 32 shows the sample to-do list of the website of FIG. 31.

FIG. 33 shows the sample document list of the website of FIG. 31.

FIG. 34 shows a sample of the study announcements of the website of FIG. 31.

FIG. 35 shows a sample of the study contacts of the website of FIG. 31.

FIG. 36 shows a sample of the study links of the website of FIG. 31.

FIG. 37 shows a sample of the study report of the website of FIG. 31.

FIG. 38 shows an exemplary landing page of the collaboration portal.

FIG. 39 shows an exemplary landing page of a specific clinical trial in the collaboration portal.

FIG. 40 shows a “My Trial Profile” page that allows external users to maintain trial specific addresses (locations) for their facility.

FIG. 41 shows the Contact List web page which displays information about the personnel from the sponsor organization that the user must interact with during the conduct of the clinical trial.

FIG. 42 shows the Product File of the Trial Master File.

FIG. 43 shows the Study File of the Trial Master File.

FIG. 44 shows the Country File of the Trial Master File.

FIG. 45 shows the Site File of the Trial Master File.

FIG. 46 shows a web page that presents the user with a list of predefined documents to upload or the option to upload a document that is not on the list.

FIG. 47 shows an Upload Site Document page that appears if the external user clicks on one of the predefined documents (for example “Upload CV”) of FIG. 46.

FIG. 48 shows the Upload Site Document web form that allows an external user to browse and select the file he/she intends to upload and identifies the document by entering the name and title of the document and clicking the button labeled “Check-In”.

FIG. 49 shows a page listing application URLs that the external user can select to access other web-based clinical trial applications.

FIG. 50 shows the invite investigator page that the study manager may browse to identify clinical investigators that possess the attributes needed for a specific clinical trial.

FIG. 51 shows invite investigator page that the study manager uses to select previously selected investigators from the invitee list by clicking the button labeled “Remove Selected Investigators.”

FIG. 52 shows the process for inviting investigators to participate in a clinical trial.

FIG. 53 shows the software layout of the clinical portal home page.

FIG. 54 shows the software layout of the clinical trial workspace home page.

### DETAILED DESCRIPTION OF ILLUSTRATIVE EMBODIMENTS

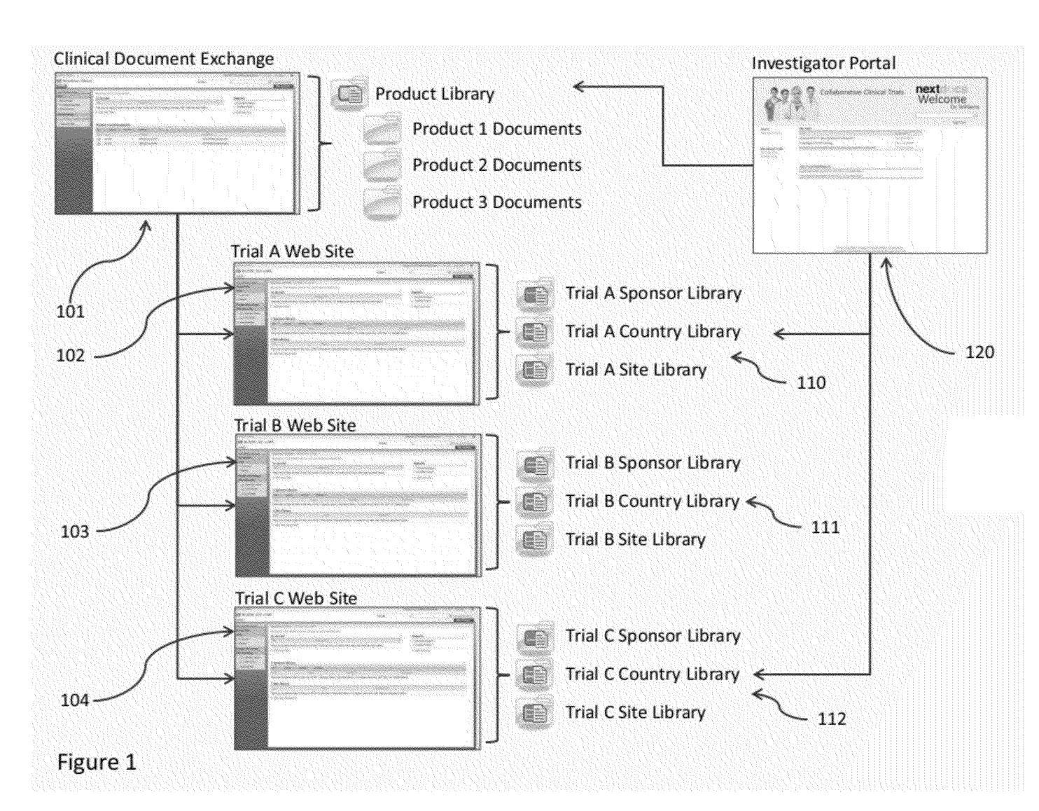

Certain specific details are set forth in the following description with respect to FIGS. 1-54 to provide a thorough understanding of various embodiments of the invention. Certain well-known details are not set forth in the following disclosure, however, to avoid unnecessarily obscuring the various embodiments of the invention. Those of ordinary skill in the relevant art will understand that they can practice other embodiments of the invention without one or more of the details described below. Also, while various methods are described with reference to steps and sequences in the following disclosure, the description is intended to provide a clear implementation of embodiments of the invention, and the steps and sequences of steps should not be taken as required to practice the invention.

FIG. 1 shows the architecture of the collaborative clinical trials system of the invention. As illustrated, a website 101 called the Clinical Document Exchange (CDE) or administrator portal is accessed to provide access to clinical trial websites 102, 103, and 104. The website 101 includes a button that the trial sponsor or administrator may select to automatically create the trial websites 102, 103, and 104. Each trial website is used to administer the clinical trial for a certain drug. Each clinical trial is conducted on several trial sites such as hospitals, clinics and academic institutions. For each trial site, the trial sponsor sets up a separate folder of files to support the trial. The file folders 110-112 are called the Trial Master File. The trial sponsor selects a button on the clinical trial website to generate these files. An Investigator portal 120 provides a website for the principal investigator to use at the trial site to stay informed of important information regarding the trial by accessing current versions of essential documents that govern the conduct of the clinical trial in real-time. As explained below, the principal investigator also uses this Investigator Portal 120 to upload documents related to the clinical trial.

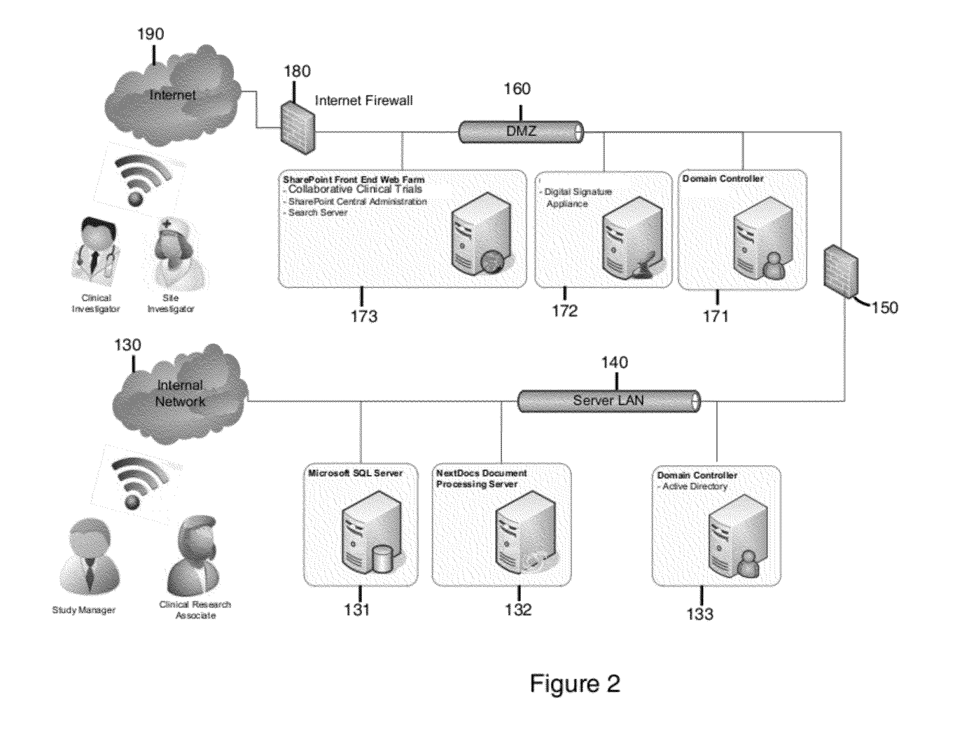

An exemplary embodiment of the invention implements the collaborative clinical trials system in software on a server and/or a collection of servers and implements the collaboration portal using a Microsoft SharePoint content management software system. The workflows may also be implemented using the Nintex Workflow software module that determines the order and sequence of the template presentations for generating the administrator and Investigator portals as well as the clinical trial websites from a Trial Master File as described herein. In the exemplary embodiment, the collaborative trials system software, collaboration portal software, and workflow software are implemented in a system of the type illustrated in FIG. 2.

FIG. 2 shows a hardware configuration for implementing the collaborative clinical trials system of the invention. As illustrated, the study manager, clinical research associate, and others managing the clinical trial communicate over an internal network 130 with a Microsoft SQL server 131, a document processing server 132, and with a domain controller 133 containing an Active Directory, all via LAN 140. In turn, the LAN 140 communicates via a DMZ firewall 150 with a DMZ LAN 160. The DMZ LAN 160 provides for communications with a domain controller 171 including Active Directory Lightweight Directory Services (AD LDS), a digital signature appliance 172, and a SharePoint front end web farm 173 that processes the collaborative clinical trials software of the invention to provide central administration of clinical trials and search software for finding desired information in the illustrated network. An Internet firewall 180 separates the DMZ LAN 160 from the Internet. As illustrated, outside clinical and site investigators communicate with the illustrated system over the Internet 190 via extranet access through the Internet firewall 180.

Those skilled in the art will appreciate that the servers 131-133 and 171-173 illustrated in FIG. 2 are adapted to store and execute the collaborative trials system software, collaboration portal software, workflow software, and extranet access control software described herein. Generally speaking, each server includes a memory and processor that runs the software stored in its memory to implement the features described herein. Those skilled in the art will appreciate that the servers may include computing environments implemented by a personal computer, a mainframe, or the like. According to the illustrated embodiment, the computing environment includes hardware components and/or software components such that the resulting computing environment may be used to execute applications such as collaborative trials system software, collaboration portal software, workflow software, or the like. For example, the computing environment on each server may be used to execute the collaborative trials system software, collaboration portal software, and workflow software for implementing the methods described herein with respect to FIGS. 1-54.

In an exemplary embodiment, the processor of each server is in operative communication with an instruction memory with instructions for implementing an operating system and the application programs for implementing the techniques of the invention. The processor may include a standardized processor, a specialized processor, a microprocessor, or the like. The processor executes instructions including, for example, instructions for implementing the processes described with respect to FIG. 1-54.

The instruction memory stores the instructions that may be executed by the processor of the associated server. The instruction memory may include computer readable storage media in the form of volatile and/or nonvolatile memory such as random access memory (RAM), read only memory (ROM), cache, Flash memory, a hard disk, or any other suitable storage component. In one embodiment, the instruction memory may be a separate component in communication with the processor, while in another embodiment, the instruction memory may be integrated into the processor of the associated server.

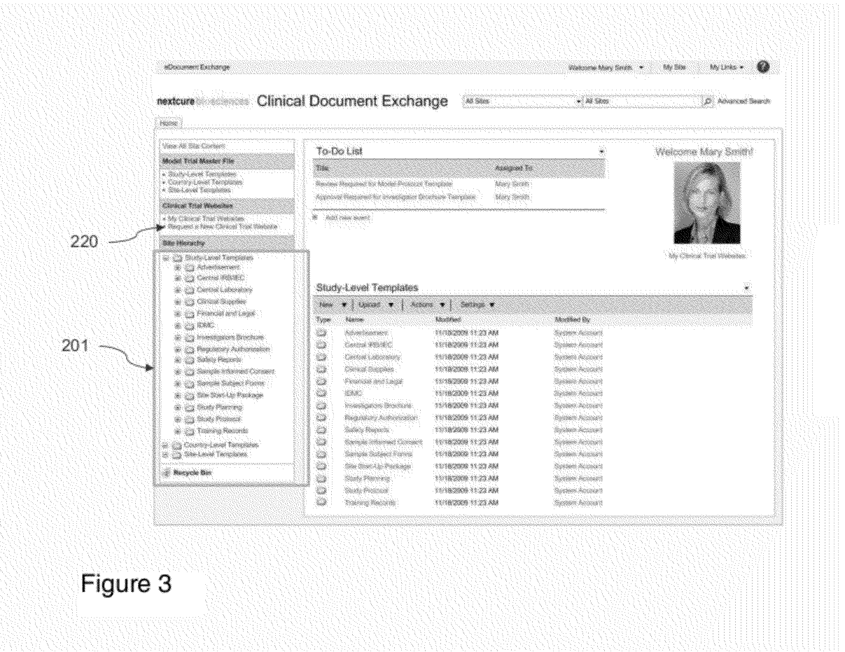

FIG. 3 shows the Clinical Document Exchange (CDE) portal 101. This portal website shows the Trial Master File structure 201 which is the default file structure used by the trial sponsor for clinical trials. A link 220 is used to create a new clinical trial website. In an exemplary embodiment, the CDE portal described is implemented in the Microsoft SharePoint content management software system and enables the trial sponsor or administrator to modify the Trial Master File structure 201 and files using SharePoint's file editing capabilities. SharePoint's editing capabilities also may be supplemented with the Nintex Workflow software module to present the templates in a predetermined order and sequence to create the collaboration website automatically from the data stored in the Trial Master File.

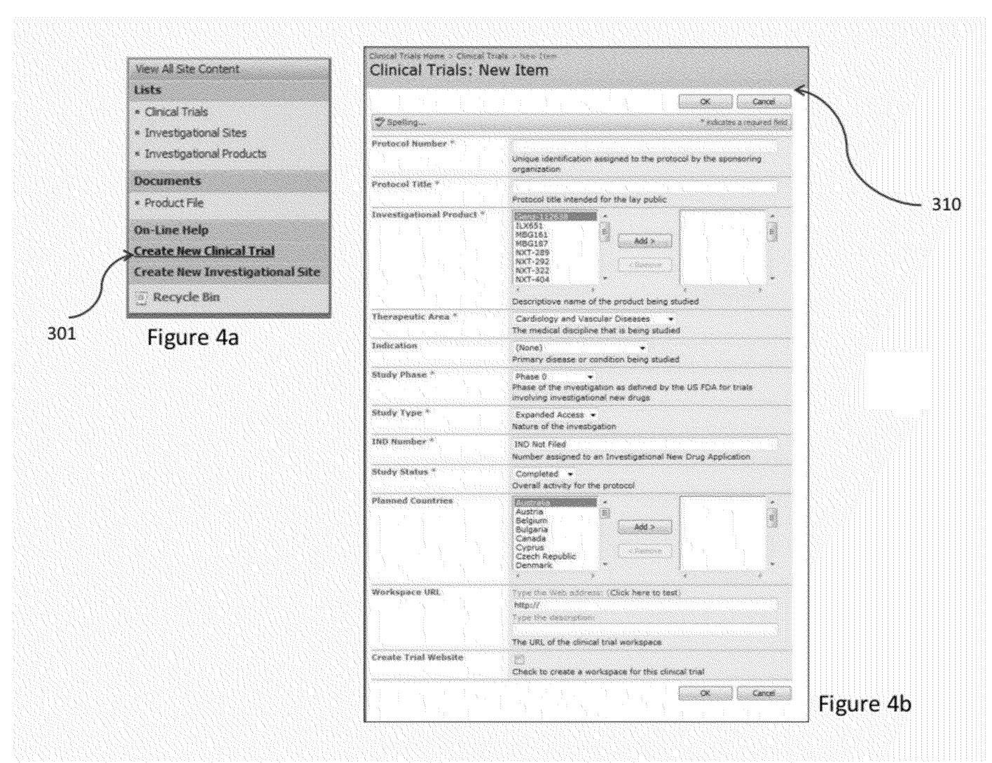

FIG. 4a shows the menu used to set up a new clinical trial website. When the trial sponsor clicks on the link 301, a window 310 of the type shown in FIG. 4b, prompts the trial sponsor to enter the relevant information for the clinical trial. After the trial sponsor enters the required information in window 310, a new clinical trial website is automatically created using a conventional software wizard.

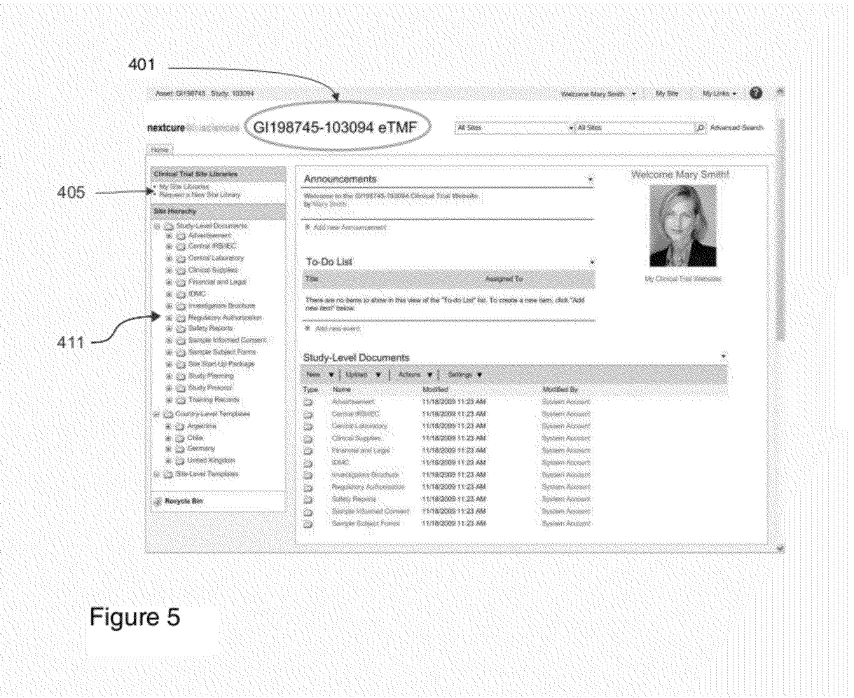

FIG. 5 shows an exemplary clinical trial portal. As illustrated, each clinical trial website is given a unique identifier 401. The new clinical trial website includes a Trial Master File structure 411 and includes copies of the files from the Trial Master File 201. Menu 405 is used by the trial sponsor to create a new trial site website.

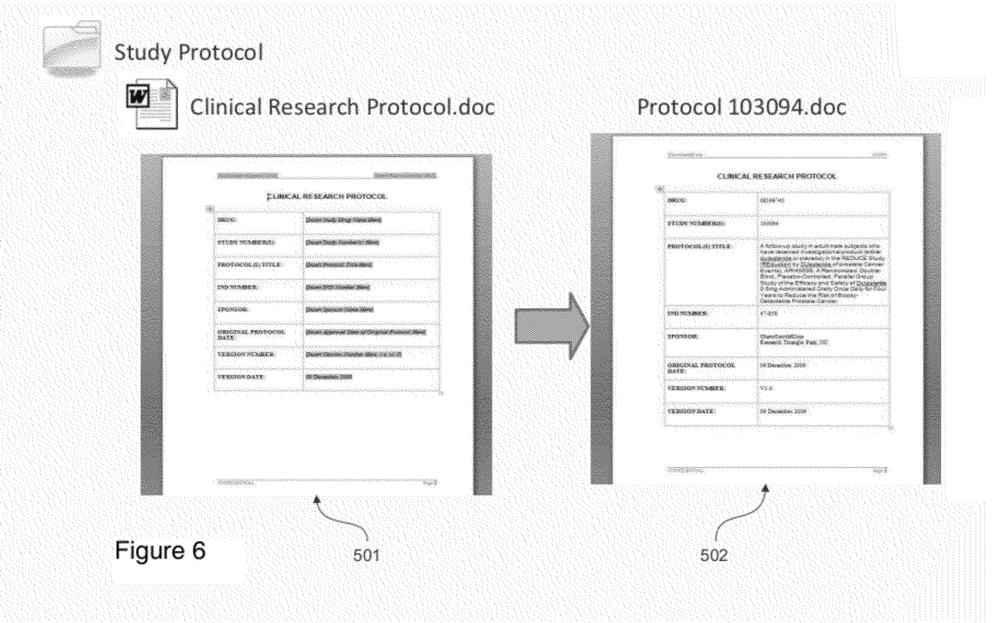

FIG. 6 shows the process for customizing the documents from the Trial Master File to become trial specific. As illustrated, the original document 501 contains the main template for the clinical research protocol, where the templates are presented in an order and sequence directed by workflow management software. The site sponsor edits the allowed fields in the document 501 to turn it into a trial-specific document 502 for the identified trial 103094.

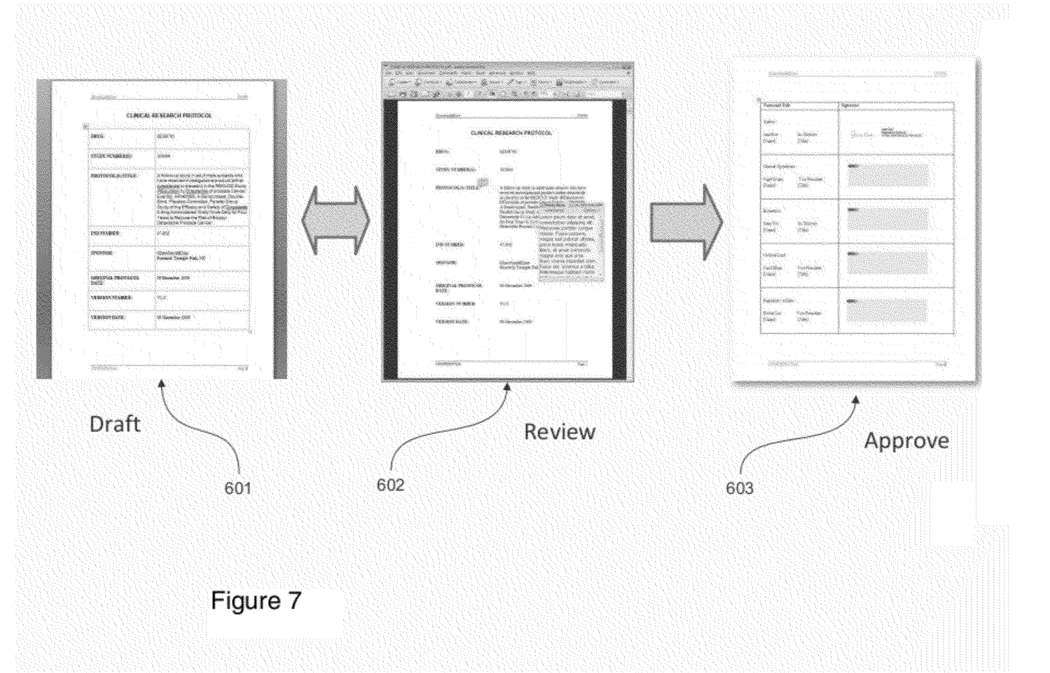

FIG. 7 shows how a trial specific document is edited and approved. The draft of the document 601 is reviewed by a trial sponsor reviewer. The reviewer adds comments to the draft in document 602. The comments can then be included in the draft for approval and signature in document 603. When the document 603 is approved, it is included as a standard document in the Trial website. In an exemplary embodiment, the review process is managed by standard Microsoft Office and Adobe Acrobat editing features. The approval signatures are collected with a digital signature system such as a Co-sign system made by Algorithmic Research (see element 172 of FIG. 2). The Nintex Workflow module is used to coordinate the workflow of this process from the data stored in the Trial Master File.

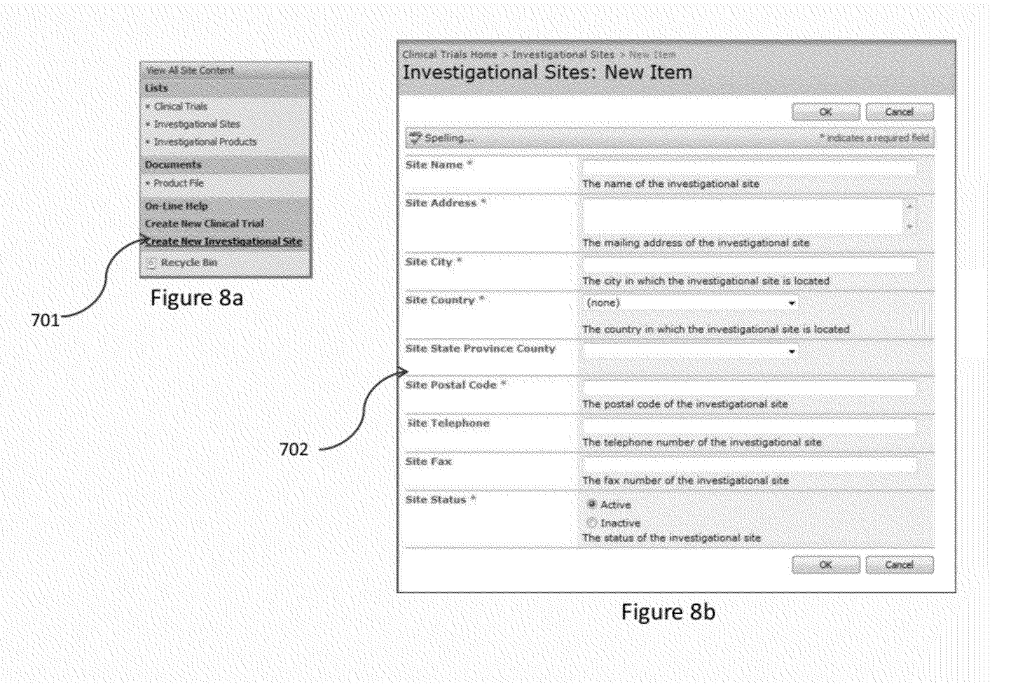

FIG. 8a shows the menu used to create a new Trial Site Folder within the Trial Site Library. When the trial sponsor clicks on the “Request a New Trial Site” link 701, the trial sponsor is asked to answer the questions in window 702 in FIG. 8b. The site sponsor is asked to fill out the following information: Investigational Products, Study Number, Site Number, Site Name, Site Country, Site Address, Site Town, Site State, Site Postal Code, Site Phone, Site Fax, Principal Investigator, Email address, Site status, and method of Safety Report Distribution. When the questions are answered, a new Trial Site Folder is created within the Trial Site Library. The Trial Site Folder has all the files needed for the trial site to administer the clinical trial.

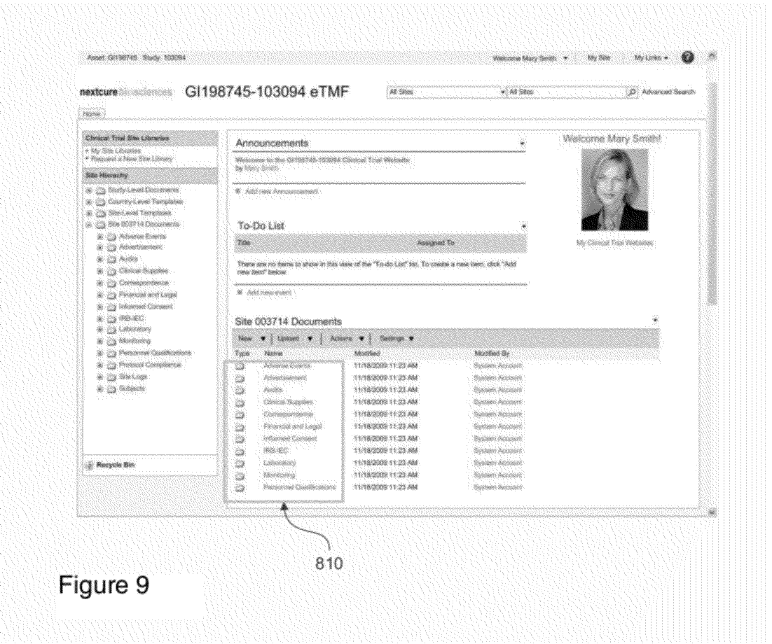

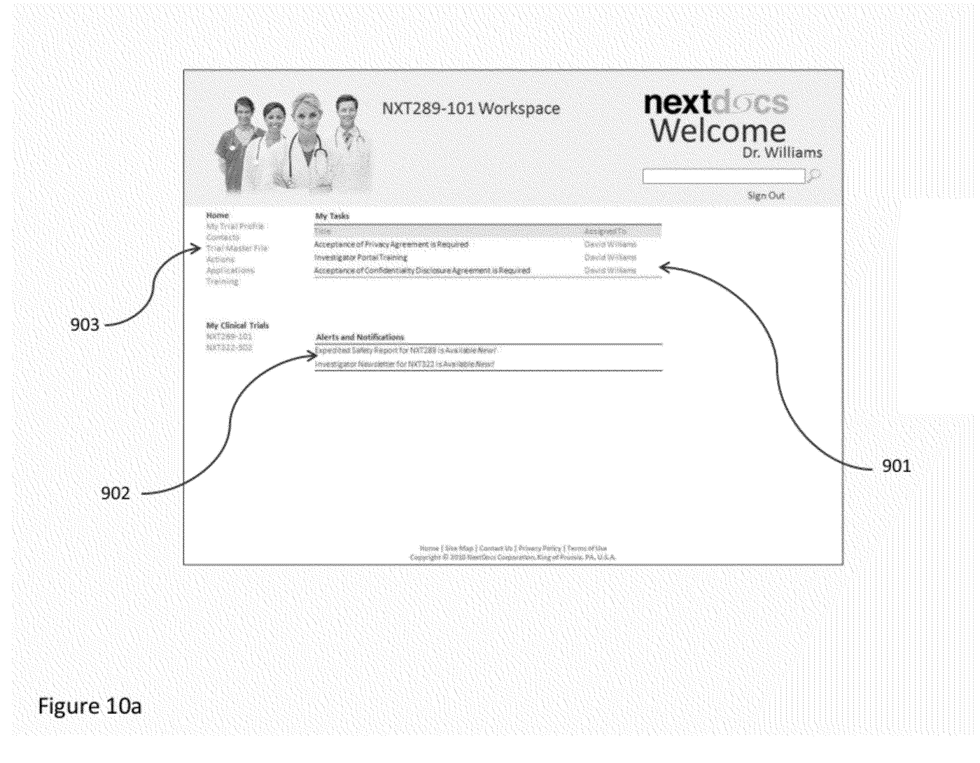

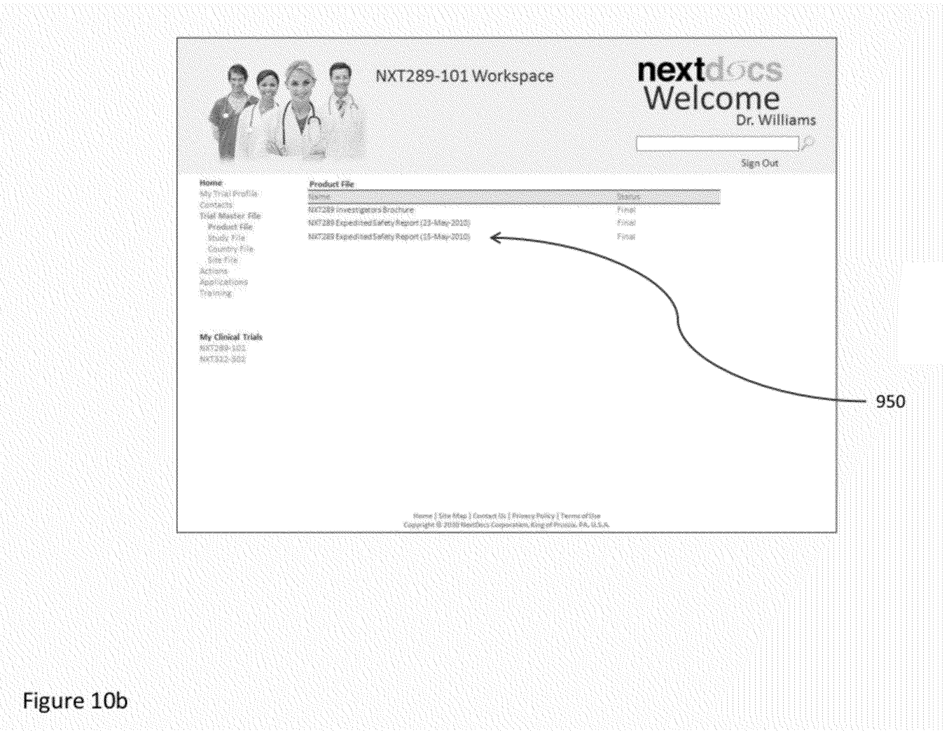

The Trial Site Library can be viewed and modified by the trial sponsor as well as the principal investigator and other staff at the trial site. FIGS. 9 and 10 show the SharePoint pages that serve as the front-end to the Trial Site Library. In particular, FIG. 9 shows the view of the Trial Site Library from the trial sponsor's perspective. Folder 810 shows the site-level documents used when setting up a trial site folder. On the other hand, FIG. 10a shows the Investigator Portal view of the Trial Master File. The items that require action by the investigator appear on the to-do web part 901. Investigators are kept abreast of upcoming events and study alerts through calendar and notification web-parts 902. The Trial Master File documents are accessed through the document list 903. FIG. 10b shows the Investigator portal with the adverse events documents folder's hierarchy 950 exposed. When a new adverse event document is added to the list, the principal investigator is notified by email with a link to the relevant document. In the exemplary embodiment, the Investigator portal is also implemented in SharePoint, and the Trial Master File documents are modified using standard SharePoint editing features.

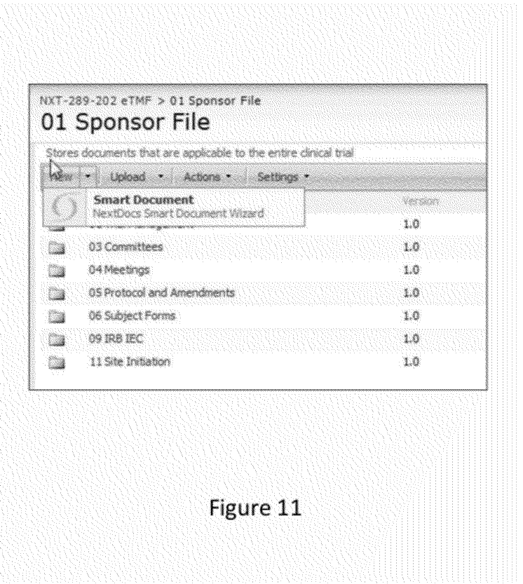

FIGS. 11-16 show how the sponsor personnel upload documents using a wizard in the Clinical Document Exchange portal. Without this wizard, the sponsor personnel would need to be trained on the directory structure used in the Trial Master File. The wizard makes it easy for the sponsor personnel to upload trial documents without having to know the directory structure of the TrialMaster File.

The Smart Document Wizard (SDW) is a utility that greatly simplifies the configuration and management of system applications by reducing the number of site content types required to meet business requirements. The SDW is a server-generated web page based on ActiveX scripting that uses the Microsoft ASP.NET framework. The code is first processed on the web server 173 (FIG. 2) and the resulting HTML code is sent to the user's web browser. The web page is generated based on configuration metadata that is stored in a series of SharePoint lists which are described below. The SDW web page performs the following functions when a new document is created or uploaded into a SharePoint library:

1. Captures the metadata to classify the document and create the document as the correct content type;

2. Captures the metadata to correctly index the document;

3. Creates the correct folder structure within the library to store the document (if it does not already exist); and

4. Attach the proper authoring template to the document when it is created (does not apply to uploaded documents).

The following exemplary list defines the inventory of artifacts that can be created within the SharePoint site.

| Column | Column | | |
|---|---|---|---|
| Name | Type | Description | Comments |
| Domain | Text | The highest level | Examples: Sponsor File, |
| Name | | of document | Country File, Site File |
| | | classification | |
| Group | Text | The level of document | Examples: Protocols and |
| Name | | classification below | Amendments, Subject |
| | | Domain Name | Forms |
| Artifact | Text | The level of document | Example: Curriculum |
| Name | | classification below | Vitae, Informed |
| | | Group Name | Consent Form |
| Parent | Text | The name of the Site | Example: Clinical Study |
| Content | | Content Type the | Document, Clinical Site |
| Type | | artifact will be | Document |
| | | created as | |
| Template | Text | The name of the | Templates are stored in |
| Name | | authoring template | the Template Library |
| | | that will be | |
| | | attached to the | |
| | | document | |
| Folder | Text | The folder structure | Example: (Site File)>[Site |
| Path | | that the document | Country]>[Site |
| | | will be stored in | Name]>Start-up |
| | | | Documents |
| | | | Note: Library name is in |
| | | | parenthesis ( ) and property |
| | | | values are in |
| | | | brackets [ ] t |

The following are sample list entries based on the above list.

| | | | Parent | | |
|---|---|---|---|---|---|
| | | Artifact | Content | | |
| Domain Name | Group Name | Name | Type | Template Name | Folder Path |
| Product File | Investigator | Investigator | Product | Investigator Brochure | (Product File)>[Product |
| | Brochure | Brochure | Document | Template.doc | Name]>Investigators Brochure |
| Product File | Safety Reports | SUSAR | Safety | NextDocs | (Product File)> [Product |
| | | | Document | Standard.doc | Name]>Safety Reports>SUSAR |
| Product File | Safety Reports | Dear Investigator | Safety | NextDocs | (Product File)>[Product |
| | | Letter | Document | Standard.doc | Name]>Safety Reports>Dear |
| | | | | | Investigator Letters |
| Product File | Safety Reports | IND Safety Report | Safety | NextDocs | (Product File)> [Product |
| | | | Document | Standard.doc | Name]>Safety Reports>IND |
| | | | | | Safety Report |
| Product File | Safety Reports | Periodic Safety | Safety | NextDocs | (Product File)>[Product |
| | | Update Report | Document | Standard.doc | Name]>Safety Reports>Periodic |
| | | | | | Safety Update Report |
| Product File | Safety Reports | Annual Safety | Safety | NextDocs | (Product File)>[Product |
| | | Report | Document | Standard.doc | Name]>Safety Reports>Annual |
| | | | | | Safety Report |
| Trial File | Site Selection | Feasibility | Clinical Trial | NextDocs Standard | (Trial File)>Site Selection |
| | | Documentation | Document | 2003.doc | |
| Trial File | Site Selection | Sites Evaluated | Clinical Trial | NextDocs Standard | (Trial File)> Site Selection |
| | | but not Selected | Document | 2003.doc | |
| Trial File | Site Selection | Relevant | Clinical Trial | NextDocs Standard | (Trial File)> Site |
| | | Communications | Document | 2003.doc | Selection>Communications |
| Trial File | Site Selection | Meeting Material | Clinical Trial | NextDocs Standard | (Trial File)> Site |
| | | | Document | 2003.doc | Selection>Meetings |
| Trial File | Site Selection | Filenote | Clinical Trial | NextDocs Standard | (Trial File)>Site |
| | | | Document | 2003.doc | Selection>Filenotes |
| Trial File | Site Initiation | Site Training | Clinical Trial | NextDocs Standard | (Trial File)>Site Initiation |
| | | Material | Document | 2003.doc | |
| Trial File | Site Initiation | Site Training | Clinical Trial | NextDocs Standard | (Trial File)>Site Initiation |
| | | Documentation | Document | 2003.doc | |
| Trial File | Site Initiation | Relevant | Clinical Trial | NextDocs Standard | (Trial File)>Site |
| | | Communications | Document | 2003.doc | Initiation>Communications |
| Trial File | Site Initiation | Meeting Material | Clinical Trial | NextDocs Standard | (Trial File)>Site |
| | | | Document | 2003.doc | Initiation>Meetings |
| Trial File | Site Initiation | Filenote | Clinical Trial | NextDocs Standard | (Trial File)>Site |
| | | | Document | 2003.doc | Initiation>Filenotes |
| Country File | Subject Documents | Sample Case | Country | NextDocs Standard | (Country File)>[Country]>Subject |
| | | Report Form | Document | 2003.doc | Documents |
| Country File | Subject Documents | Subject Diary | Country | NextDocs Standard | (Country File)>[Country]>Subject |
| | | | Document | 2003.doc | Documents |
| Country File | Subject Documents | Subject | Country | NextDocs Standard | (Country File)>[Country]>Subject |
| | | Questionnaire | Document | 2003.doc | Documents |
| Country File | Subject Documents | Informed Consent | Country | NextDocs Standard | (Country File)>[Country]>Subject |
| | | Form | Document | 2003.doc | Documents |
| Country File | Subject Documents | Subject | Country | NextDocs Standard | (Country File)>[Country]>Subject |
| | | Information Sheet | Document | 2003.doc | Documents |
| Country File | Subject Documents | Subject | Country | NextDocs Standard | (Country File)>[Country]>Subject |
| | | Participation Card | Document | 2003.doc | Documents |
| Country File | Subject Documents | Advertisements | Country | NextDocs Standard | (Country File)>[Country]>Subject |
| | | for Subject | Document | 2003.doc | Documents |
| | | Recruitment | | | |
| Country File | Subject Documents | Other Written | Country | NextDocs Standard | (Country File)>[Country]>Subject |
| | | Information Given | Document | 2003.doc | Documents |
| | | to Subjects | | | |
| Country File | Subject Documents | Relevant | Country | NextDocs Standard | (Country File)>[Country]>Subject |
| | | Communications | Document | 2003.doc | Documents>Communications |
| Country File | Subject Documents | Meeting Material | Country | NextDocs Standard | (Country File)>[Country]>Subject |
| | | | Document | 2003.doc | Documents>Meetings |
| Country File | Subject Documents | Filenote | Country | NextDocs Standard | (Country File)>[Country]>Subject |
| | | | Document | 2003.doc | Documents>Filenotes |
| Site File | Site Startup | Acceptance of | Site Document | NextDocs Standard | (Site File)>[Site Country]>[Site |
| | Documentation | Investigator | | 2003.doc | Name]>Site Startup |
| | | Brochure | | | Documentation |
| Site File | Site Startup | Protocol Signature | Site Document | NextDocs Standard | (Site File)>[Site Country]>[Site |
| | Documentation | Page | | 2003.doc | Name]>Site Startup |
| | | | | | Documentation |
| Site File | Site Startup | Protocol | Site Document | NextDocs Standard | (Site File)>[Site Country]>[Site |
| | Documentation | Amendment | | 2003.doc | Name]>Site Startup |
| | | Signature Page | | | Documentation |
| Site File | Site Startup | Principal | Site Document | NextDocs Standard | (Site File)>[Site Country]>[Site |
| | Documentation | Investigator | | 2003.doc | Name]>Site Startup |
| | | Curriculum Vitae | | | Documentation |
| Site File | Site Startup | Sub-Investigator | Site Document | NextDocs Standard | (Site File)>[Site Country]>[Site |
| | Documentation | Curriculum Vitae | | 2003.doc | Name]>Site Startup |
| | | | | | Documentation |
| Site File | Site Startup | Other Curriculum | Site Document | NextDocs Standard | (Site File)>[Site Country]>[Site |
| | Documentation | Vitae | | 2003.doc | Name]>Site Startup |
| | | | | | Documentation |
| Site File | Site Startup | Medical License | Site Document | NextDocs Standard | (Site File)>[Site Country]>[Site |
| | Documentation | | | 2003.doc | Name]>Site Startup |
| | | | | | Documentation |
| Site File | Site Startup | FDA 1572 | Site Document | NextDocs Standard | (Site File)>[Site Country]>[Site |
| | Documentation | | | 2003.doc | Name]>Site Startup |
| | | | | | Documentation |
| Site File | Site Startup | Investigator | Site Document | NextDocs Standard | (Site File)>[Site Country]>[Site |
| | Documentation | Regulatory | | 2003.doc | Name]>Site Startup |
| | | Agreement | | | Documentation |
| Site File | Site Startup | Financial | Site Document | NextDocs Standard | (Site File)>[Site Country]>[Site |
| | Documentation | Disclosure Form | | 2003.doc | Name]>Site Startup |
| | | | | | Documentation |
| Site File | Site Startup | Confidential | Site Document | CDA Form.doc | (Site File)>[Site Country]>[Site |
| | Documentation | Disclosure | | | Name]>Site Startup |
| | | Agreement | | | Documentation |
| Site File | Site Startup | Clinical Trial | Site Document | NextDocs Standard | (Site File)>[Site Country]>[Site |
| | Documentation | Agreement | | 2003.doc | Name]>Site Startup |
| | | | | | Documentation |
| Site File | Site Startup | Indemnity | Site Document | NextDocs Standard | (Site File)>[Site Country]>[Site |
| | Documentation | | | 2003.doc | Name]>Site Startup |
| | | | | | Documentation |
| Site File | Site Startup | Other Financial | Site Document | NextDocs Standard | (Site File)>[Site Country]>[Site |
| | Documentation | Agreement | | 2003.doc | Name]>Site Startup |
| | | | | | Documentation |
| Site File | Site Startup | Local Laboratory | Site Document | NextDocs Standard | (Site File)>[Site Country]>[Site |
| | Documentation | Certification or | | 2003.doc | Name]>Site Startup |
| | | Accreditation | | | Documentation |
| Site File | Site Startup | Local Laboratory | Site Document | NextDocs Standard | (Site File)>[Site Country]>[Site |
| | Documentation | Normal Ranges | | 2003.doc | Name]>Site Startup |
| | | | | | Documentation |
| Site File | Site Startup | IP Site Release | Site Document | NextDocs Standard | (Site File)>[Site Country]>[Site |
| | Documentation | Documentation | | 2003.doc | Name]>Site Startup |
| | | | | | Documentation |
| Site File | Site Startup | Site Signature | Site Document | NextDocs Standard | (Site File)>[Site Country]>[Site |
| | Documentation | Sheet | | 2003.doc | Name]>Site Startup |
| | | | | | Documentation |
| Site File | Site Startup | Relevant | Site Document | NextDocs Standard | (Site File)>[Site Country]>[Site |
| | Documentation | Communications | | 2003.doc | Name]>Site Startup |
| | | | | | Documentation>Communications |
| Site File | Site Startup | Meeting Material | Site Document | NextDocs Standard | (Site File)>[Site Country]>[Site |
| | Documentation | | | 2003.doc | Name]>Site Startup |
| | | | | | Documentation>Meetings |
| Site File | Site Startup | Filenote | Site Document | NextDocs Standard | (Site File)>[Site Country]>[Site |
| | Documentation | | | 2003.doc | Name]>Site Startup |
| | | | | | Documentation>Filenotes |

This list defines the properties that will be defined for the document. The properties defined in the list will either be populated by the user, or will be looked up in another SharePoint by the SDW based on a key value supplied by the user. The following list also specifies the property control type and display order.

| Column | Column | | |
|---|---|---|---|
| Name | Type | Description | Comments |
| Content | Lookup | Content Type that will | Lookup site Content |
| Type | | be created by the | Types |
| | | SDW | |
| Display | Text | Determines the order | |
| Order | | of the properties on | |
| | | the SDW | |
| Column | Text | The name of the Site | |
| Name | | Column | |
| Display | Text | How the property will | |
| Name | | be displayed on the | |
| | | SDW | |
| Control | Choice | The controls | Example: Text, Look-up, |
| Type | | | Choice Date/Time |
| Lookup | Text | The name of the | Example: Product List, |
| List | | SharePoint list that | Clinical Study List |
| | | contains the valid | |
| | | values for the | |
| | | property | |
| Lookup | Text | The name of the | Example: API Name, |
| Column | | column within the | Study Title |
| | | Lookup List that | |
| | | contains the valid | |
| | | values for the | |
| | | property | |
| Lookup | Text | The name of the | Example: Product Code, |
| Key | | document property | Study Number |
| | | that serves as the key | |
| | | into the Lookup List | |
| Required | Choice | Indicates whether the | Yes/No |
| Flag | | document property is | Note: Properties that |
| | | required or optional | are used to determine |
| | | | the document |
| | | | classification and |
| | | | folder path are |
| | | | mandatory |
| Repeating | Choice | Indicates whether | Yes/No |
| Flag | | more than one value | |
| | | can be entered for the | |
| | | property | |
| Auto Fill | Choice | Indicates whether the | Yes/No |
| Flag | | property is | |
| | | automatically | |
| | | populated from a | |
| | | SharePoint List based | |
| | | on another property | |
| Auto Fill | Text | The name of the | |
| List | | SharePoint list that | |
| | | the property will be | |
| | | automatically | |
| | | populated from | |
| Auto Fill | Text | The name of the | |
| Column | | document property | |
| | | that serves as the key | |
| | | into the Auto Fill List | |
| Auto Fill | Text | The name of the | |
| Key | | document property | |
| | | that serves as the key | |
| | | into the Auto Fill List | |

The following are sample list entries based on the above list.

| | | | | | | Look | | | | Auto | | | Auto |
|---|---|---|---|---|---|---|---|---|---|---|---|---|---|
| Content | Display | Column | Display | Control | Lookup | up | Lookup | Required | Repeating | Fill | Auto | Auto | Fill |
| Type | Order | Name | Name | Type | List | Column | Key | Flag | Flag | Flag | Fill List | Fill Column | Key |
| Clinical | 1 | Product | Product | Look | Clinical | Product | | Yes | No | No | | | |
| Study | | Name | Name | up | Study | Name | | | | | | | |
| Document | | | | | List | | | | | | | | |
| Clinical | 2 | Study | Study | Look | Clinical | Study | Product | Yes | No | No | | | |
| Study | | Nbr | Number | up | Study | Nbr | Name | | | | | | |
| Document | | | | | List | | | | | | | | |
| Clinical | 3 | Dosage | Dosage | Look | Clinical | Dosage | Study | Yes | Yes | No | | | |
| Study | | Form | Form | up | Study | Form | Nbr | | | | | | |
| Document | | Strength | Strength | | List | | | | | | | | |
| Clinical | 4 | Study | Study | Text | | | | | No | Yes | Clinical | Study | Study |
| Study | | Name | Name | | | | | | | | Study | Name | Nbr |
| Document | | | | | | | | | | | List | | |
| Clinical | 5 | Study | Study | Text | | | | | No | Yes | Clinical | Study | Study |
| Study | | Discipline | Discipline | | | | | | | | Study | Discipline | Nbr |
| Document | | | | | | | | | | | List | | |
| Clinical | 6 | Study | Study | Text | | | | | No | Yes | Clinical | Study | Study |
| Study | | Sub | Sub | | | | | | | | Study | Sub | Nbr |
| Document | | Discipline | Discipline | | | | | | | | List | Discipline | |
| Clinical | 7 | Study | Study | Text | | | | | No | Yes | Clinical | Study | Study |
| Study | | Phase | Phase | | | | | | | | Study | Phase | Nbr |
| Document | | | | | | | | | | | List | | |
| Clinical | 8 | Route | Route | Text | | | | | No | Yes | Clinical | Route Of | Study |
| Study | | Of | Of | | | | | | | | Study | Admin | Nbr |
| Document | | Admin | Administration | | | | | | | | List | | |
| Clinical | 9 | Indication | Indication | Text | | | | | No | Yes | Clinical | Indication | Study |
| Study | | | | | | | | | | | Study | | Nbr |
| Document | | | | | | | | | | | | | |

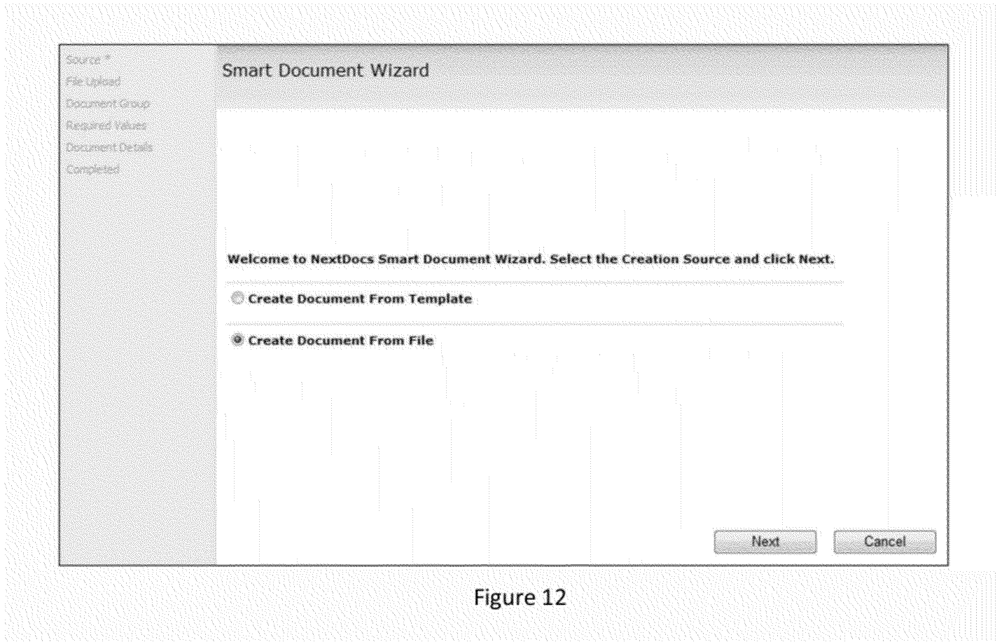

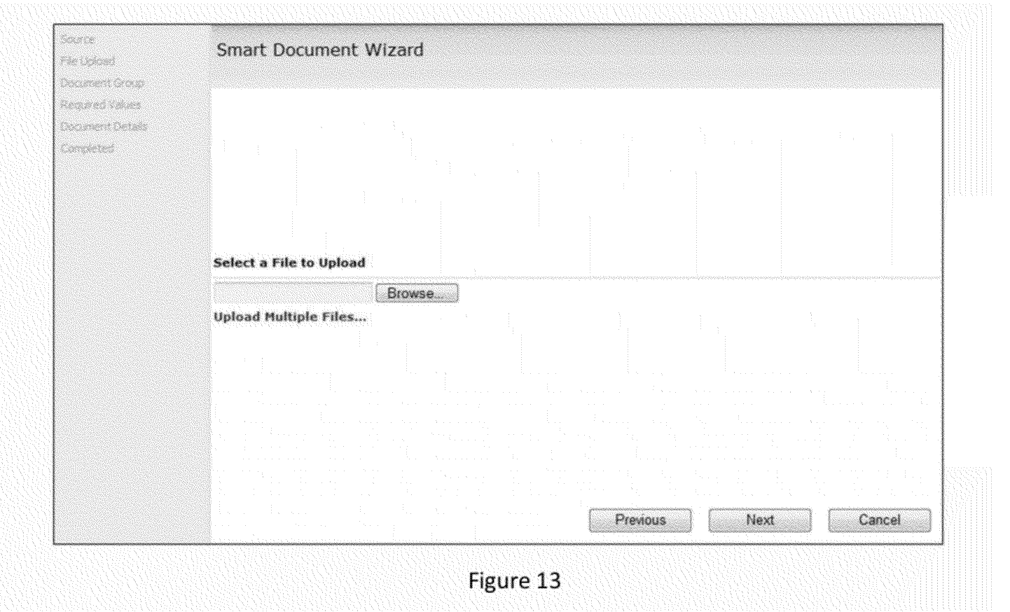

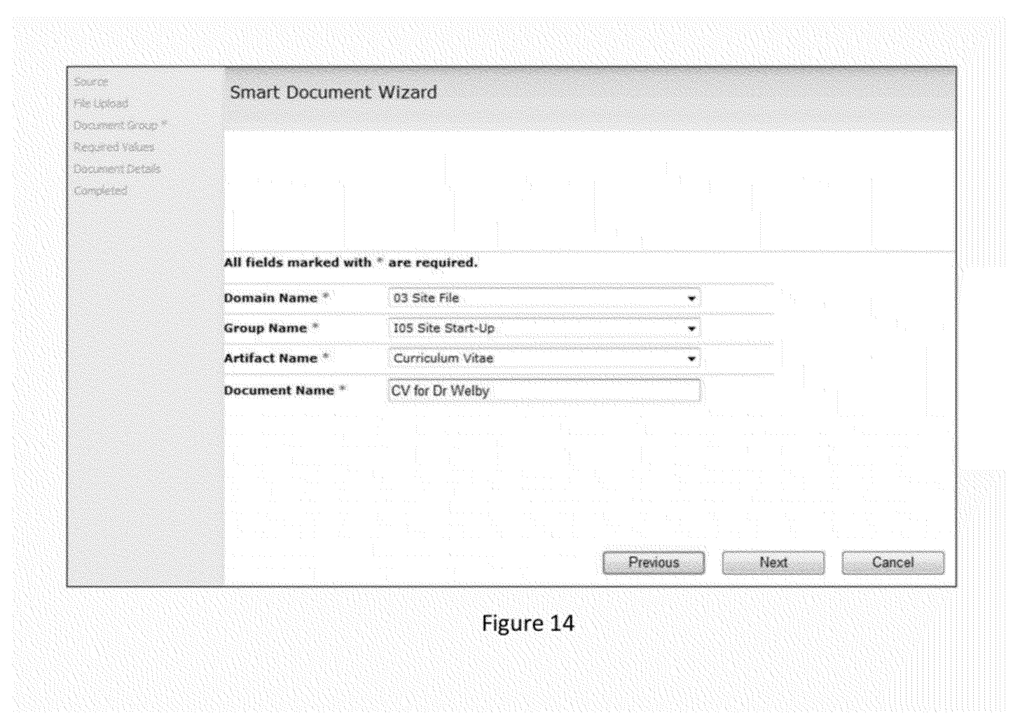

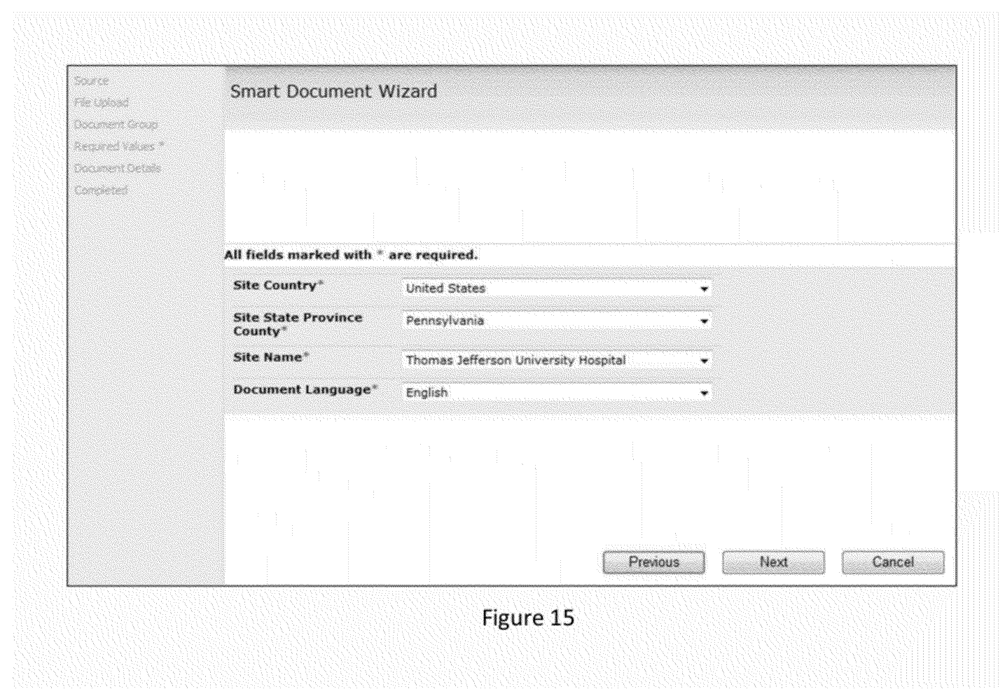

FIG. 11 shows the dropdown menu that the sponsor personnel can use to create or upload a new document. The sponsor personnel would choose the “Create a new Smart Document.” option from the menu. FIG. 12 shows the first screen of the new Smart Document Wizard (SDW). In the first step, the sponsor personnel can select if he/she wants to create a document from a template or if he/she wants to upload the document from a file. If the user selects “Upload from File,” he/she will be prompted to enter the file name in the screen show in FIG. 13. After clicking the “Next” button, the window from FIG. 14 is displayed. The Parent Content Type, Authoring Template and Folder Path are looked up in the Document Inventory List for the selected Artifact. The property information for the Parent Content Type is looked up in the Document Property List. Based on this metadata, the SDW displays required fields in FIG. 15.

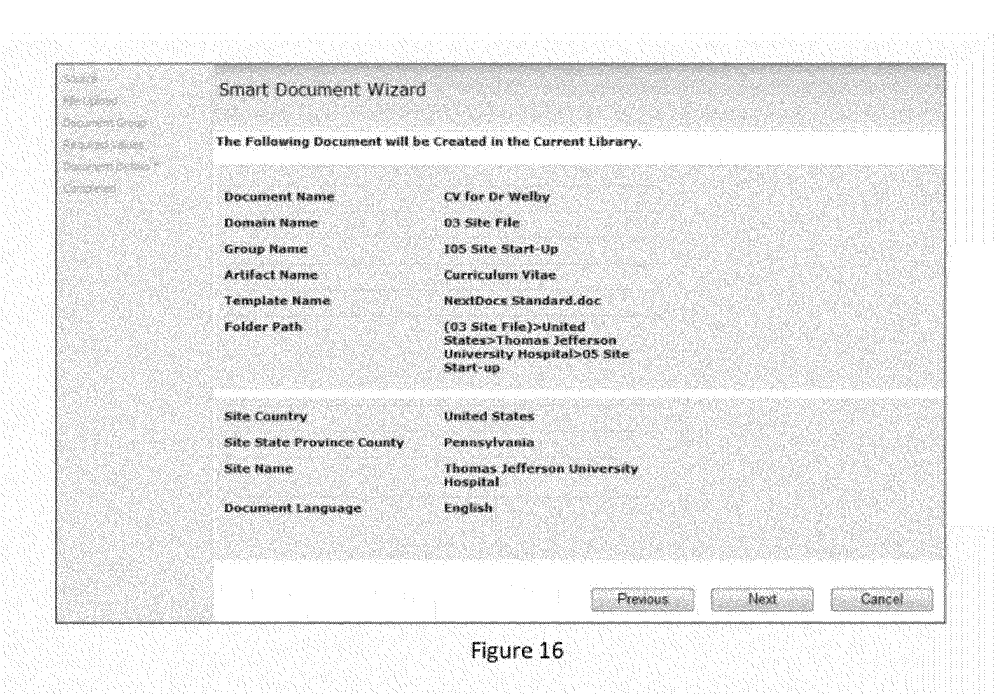

In FIG. 15, the sponsor personnel is prompted to select the site country, site state/province and site name. Other fields might be required based on the metadata from the previous step. Once the sponsor personnel populates the required properties, the SDW determines the values for the Auto Fill properties and sets them. FIG. 16 shows the confirmation panel for the document. When the principal investigator clicks the finish button in FIG. 16, the system determines if the folder structure exists in the specified library. If it does not, the folder structure is created. A document of the proper content type is created in the specified folder and the properties populated. Finally, the proper authoring template is attached to the document and Microsoft Word is opened.

### Clinical Module Design

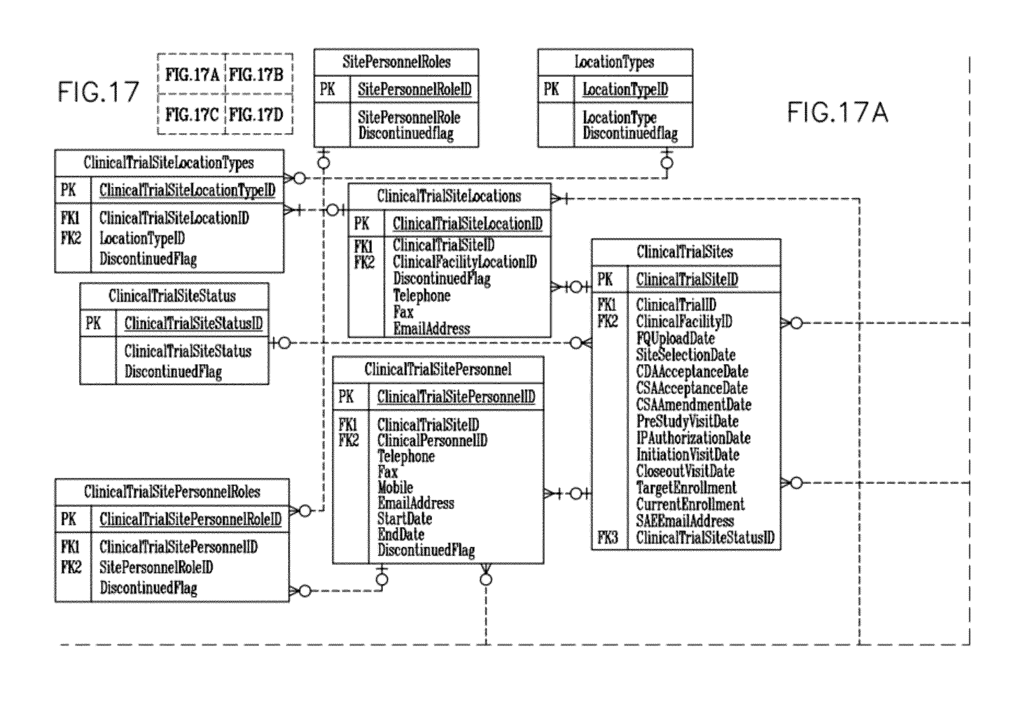

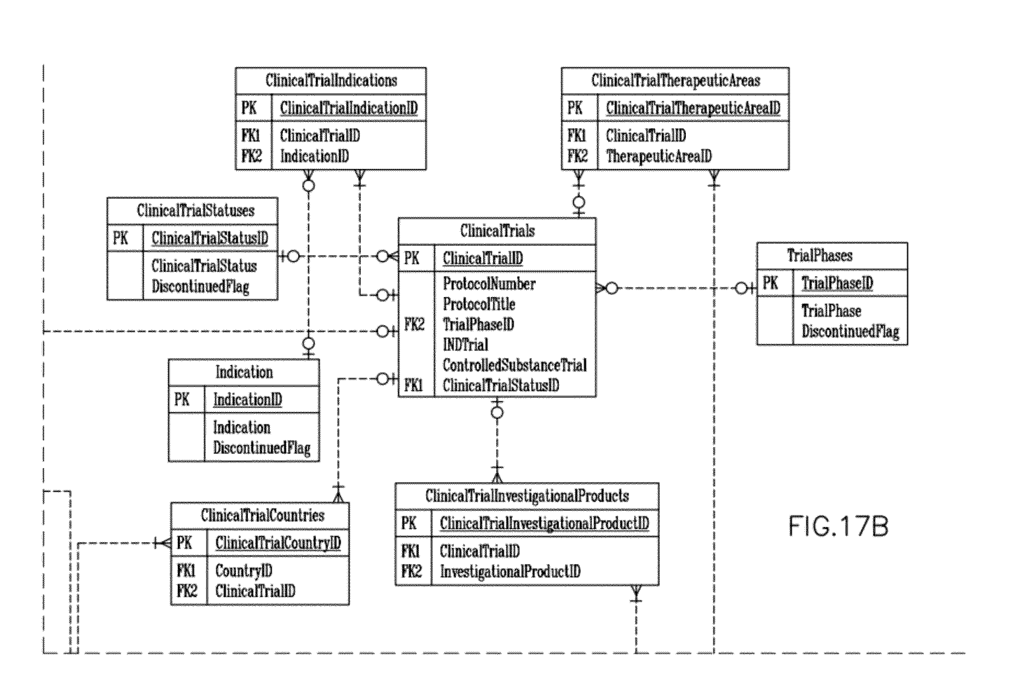

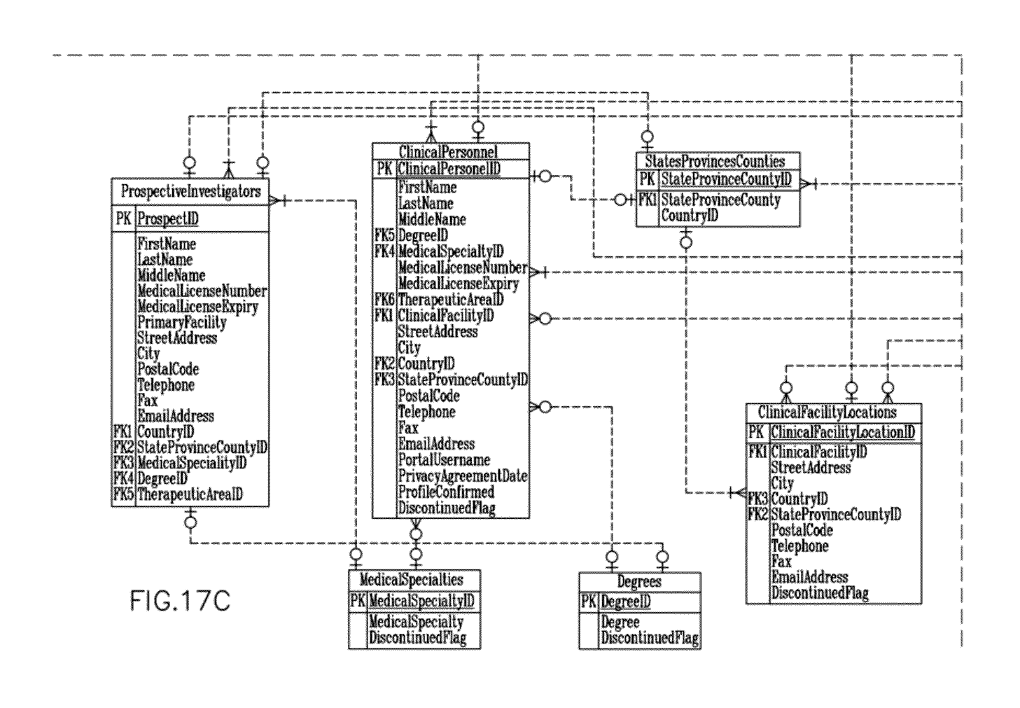

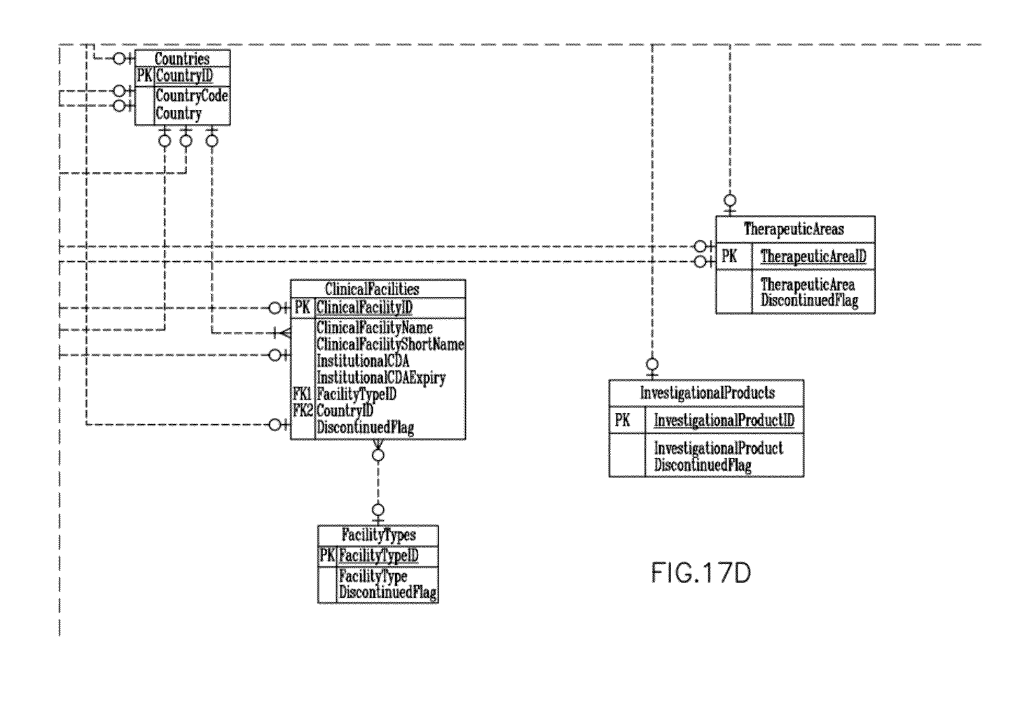

The clinical module includes a number of custom SharePoint lists that are used to control much of the functionality described herein. The creation and subsequent approval of certain list items trigger automated processes to create clinical trial websites, clinical trial site libraries and safety report distribution between the administrator and investigators. Many of these lists and list items are interrelated and the efficient management of this information is critical to the operation of the system. The diagram in FIG. 17 represents the logical data model for the key lists that are included in an exemplary embodiment of the clinical module. The logical data model represents the abstract structure of the information managed with the domain of Clinical Collaboration Portal. The logical data model is organized in terms of entities and relationships and is independent of any particular data management technology. It becomes the basis of the physical data model that is manifested as a collection of SharePoint lists.

In accordance with the invention, an entity may be defined as a thing that is recognized as being capable of independent existence and can be uniquely identified. Entities are represented as rectangles in FIG. 17. For example, in FIG. 17, Clinical Trials, Investigational Sites and Site Personnel are all considered entities. Each entity has properties that describe or identify it. Properties are listed inside each entity rectangle in FIG. 17. The property (or combination of properties) that uniquely identifies an instance of an entity is called a Primary Key and is labeled with a “PK” within the entity rectangle. A property that links an entity to the Primary Key of another entity is called a Foreign Key and is labeled with a “FK” within the entity rectangle. For example, the Clinical Trial entity has two properties, Protocol Number and Protocol Title that are used to describe instances of the entity. Additionally, it has a property called Clinical Trial ID that is the Primary Key that uniquely identifies an instance of the entity. It also has the Foreign Key properties Indication ID, Phase ID, Study Type ID, Product ID and Study Status ID that link it to the Indications, Study Phases, Investigational Product and Study Status entities, respectively.

Relationships can be thought of as links between two or more entities and are represented by the arrows that connect each of the entities in FIG. 17. Relationships between entities can be subject to cardinality rules (e.g. one-to-one, or one-to-many). For example, the Clinical Trial entity may have a link to one, and only one Indication entity.

The following tables represent the Physical Data Model as SharePoint Lists:

| | | | |
|---|---|---|---|
| | | Allow | |
| | | Multiple | |
| Column Name | Type | Values | Status |

List Name: Investigational Products

| | | |
|---|---|---|
| ID | Number | Required |
| Investigational | Single line of text | Required |
| Product | | |
| Discontinued Flag | Yes/No | Optional |

List Name: Indications

| | | |
|---|---|---|
| ID | Number | Required |
| Indication | Single line of text | Required |
| Discontinued Flag | Yes/No | Optional |

List Name: Countries

| | | |
|---|---|---|
| ID | Number | Required |
| Country Name | Single line of text | Required |
| Country Code | Single line of text | Required |
| Discontinued Flag | Yes/No | Optional |

List Name: States Provinces Counties

| | | | |
|---|---|---|---|
| ID | Number | | Required |
| Country Name | Lookup (Countries) | No | Required |
| State Province County | Single line of text | | Required |
| Discontinued Flag | Yes/No | | Optional |

List Name: Therapeutic Areas

| | | |
|---|---|---|
| ID | Number | Required |
| Therapeutic Area | Single line of text | Required |
| Discontinued Flag | Yes/No | Optional |

List Name: Clinical Trial Phases

| | | |
|---|---|---|
| ID | Number | Required |
| Clinical Trial Phase | Single line of text | Required |
| Discontinued Flag | Yes/No | Optional |

List Name: Clinical Trial Statuses

| | | |
|---|---|---|
| ID | Number | Required |
| Clinical Trial Status | Single line of text | Required |
| Discontinued Flag | Yes/No | Optional |

List Name: Clinical Trial Statuses

| | | |
|---|---|---|
| ID | Number | Required |
| Clinical Trial Status | Single line of text | Required |
| Discontinued Flag | Yes/No | Optional |

List Name: Clinical Trials

| | | | |
|---|---|---|---|
| ID | Number | | Required |
| Protocol ID | Single line of text | | Optional |
| Protocol Brief Title | Single line of text | | Required |
| Protocol Official | Multiple lines of text | | Optional |
| Title | | | |
| Investigational | Lookup | Yes | Required |
| Product | (Investigational | | |
| | Products) | | |
| Clinical Trial Phase | Lookup (Clinical | No | Required |
| | Trial Phases) | | |
| Therapeutic Area | Lookup (Therapeutic | Yes | Required |
| | Areas) | | |
| Indication | Lookup (Indications) | Yes | Required |
| Planned Countries | Lookup (Countries) | Yes | Optional |
| Planned Enrollment | Number | | Optional |
| Current Enrollment | Number | | Optional |
| Clinical Trial Status | Lookup | No | Required |
| Workspace URL | Hyperlink or Picture | | Optional |

List Name: Clinical Facilities

| | | | |
|---|---|---|---|
| ID | Number | | Required |
| Facility Name | Single line of text | | Required |
| Street Address | Multiple lines of text | | Required |
| City | Single line of text | | Required |
| Country | Lookup (Countries) | No | Required |
| State Province | Lookup (States | No | Optional |
| County | Provinces Counties) | | |
| Postal Code | Single line of text | | Required |
| Telephone | Single line of text | | Optional |
| Fax | Single line of text | | Optional |
| Discontinued Flag | Yes/No | | Required |

List Name: Clinical Facilities Locations

| | | | |
|---|---|---|---|
| ID | Number | | Required |
| Country | Lookup | No | Required |
| Facility Name | Lookup | No | Required |
| Street Address | Multiple lines of text | | Required |
| City | Single line of text | | Required |
| State Province County | Lookup | No | Optional |
| Postal Code | Single line of text | | Required |
| Telephone | Single line of text | | Optional |
| Fax | Single line of text | | Optional |
| Discontinued Flag | Yes/No | | Required |

List Name: Medical Specialties

| | | |
|---|---|---|
| ID | Number | Required |
| Medical Specialty | Single Line of text | Required |
| Discontinued Flag | Yes/No | Required |

List Name: Clinical Personnel

| | | | |
|---|---|---|---|
| ID | Number | | Required |
| First Name | Single line of text | | Required |
| Middle Name | Single line of text | | Optional |
| Last Name | Single line of text | | Required |
| Title | Single line of text | | Optional |
| Degree | Choice | | Optional |
| Medical Specialty | Lookup (Medical | Yes | Optional |
| | Specialties) | | |
| Medical License | Single line of text | | Optional |
| Number | | | |
| Medical License | Date and Time | | Optional |
| Expiry | | | |
| Therapeutic Areas | Lookup (Therapeutic | Yes | Optional |
| | Areas) | | |
| Street Address | Multiple lines of text | | Required |
| City | Single line of text | | Required |
| Country | Lookup (Countries) | No | Required |
| State Province | Lookup (State Province | | Required |
| County | County) | | |
| Postal Code | Single line of text | | Required |
| Primary Clinical | Lookup (Clinical | No | Optional |
| Facility | Facilities) | | |
| Telephone | Single line of text | | Required |
| Fax | Single line of text | | Optional |
| Email Address | Single line of text | | Required |
| Discontinued Flag | Yes/No | | Required |

List Name: Clinical Trial Site Statuses

| | | |
|---|---|---|
| ID | Number | Required |
| Clinical Trial Site | Single line of text | Required |
| Status | | |
| Discontinued Flag | Yes/No | Required |

List Name: Clinical Trial Site

| | | | |
|---|---|---|---|
| ID | Number | | Required |
| Protocol ID | Lookup (Clinical | No | Required |
| | Trials) | | |
| Facility ID | Lookup (Clinical | No | Required |
| | Facilities) | | |
| Facility Name | Lookup (Clinical | No | Required |
| | Facilities) | | |
| Country | Lookup (Countries) | No | Required |
| FQ Upload Date | Date and Time | | Optional |
| Site Selection Date | Date and Time | | Optional |
| CDA Acceptance Date | Date and Time | | Optional |
| IPA Authorization | Date and Time | | Optional |
| Date | | | |
| CSA Acceptance Date | Date and Time | | Optional |
| CSA Amendment Date | Date and Time | | Optional |
| Target Enrollment | Number | | Optional |
| Current Enrollment | Number | | Optional |
| SAE Email Address | Single line of text | | Optional |
| Pre-Study Visit Date | Date and Time | | Optional |
| Initiation Visit | Date and Time | | Optional |
| Date | | | |
| Close Out Date | Date and Time | | Optional |
| Clinical Trial | Lookup (Clinical Trial | No | Required |
| Site Status | Site Statuses) | | |

List Name: Facility Location Types

| | | |
|---|---|---|
| ID | Number | Required |
| Facility Location | Single Line of text | Required |
| Type | | |
| Discontinued Flag | Yes/No | Required |

List Name: Clinical Trial Site Locations

| | | | |
|---|---|---|---|
| ID | Number | | Required |
| Clinical Trial | Lookup (Clinical | No | Required |
| Site ID | Trial Sites) | | |
| Location ID | Lookup (Clinical | No | Required |
| | Facility Locations) | | |
| Location Type | Lookup (Facility | Yes | Required |
| | Location Type) | | |
| Telephone Number | Single line of text | | Optional |
| Fax Number | Single line of text | | Optional |
| Email Address | Single line of text | | Optional |
| Discontinued Flag | Yes/No | | Required |
| Primary Location | Yes/No | | Required |
| Flag | | | |

List Name: Site Personnel Roles

| | | |
|---|---|---|
| ID | Number | Required |
| Site Personnel Role | Single Line of text | Required |
| Discontinued Flag | Yes/No | Required |

List Name: Clinical Trial Site Personnel

| | | | |
|---|---|---|---|
| ID | Number | | Required |
| Clinical Trial | Lookup (Clinical | No | Required |
| Site ID | Trial Sites) | | |
| Personnel ID | Lookup (Clinical | No | Required |
| | Personnel) | | |
| First Name | Single line of text | | Required |
| Last Name | Single line of text | | Required |
| Middle Name | Single line of text | | Optional |
| Telephone Number | Single line of text | | Required |
| Fax Number | Single line of text | | Optional |
| Mobile Number | Single line of text | | Optional |
| Email Address | Single line of text | | Required |
| Personnel Role | Lookup (Site | Yes | Required |
| | Personnel Roles) | | |
| Start Date | Date and Time | | Optional |
| End Date | Date and Time | | Optional |
| Profile Submitted | Yes/No | | Required |
| Financial Disclosure | Yes/No | | Required |
| Flag | | | |
| Discontinued Flag | Yes/No | | Required |

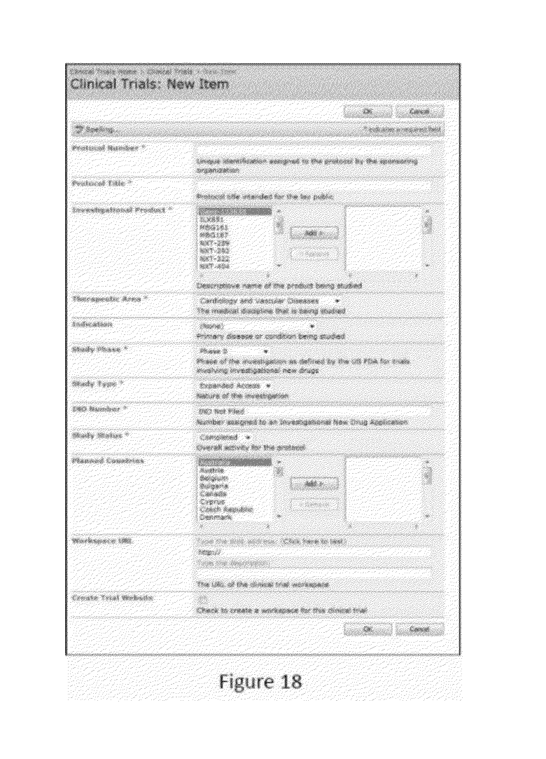

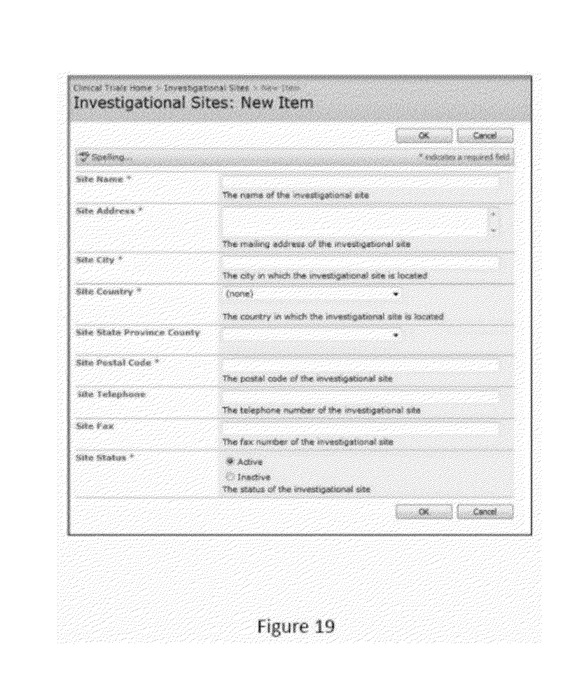

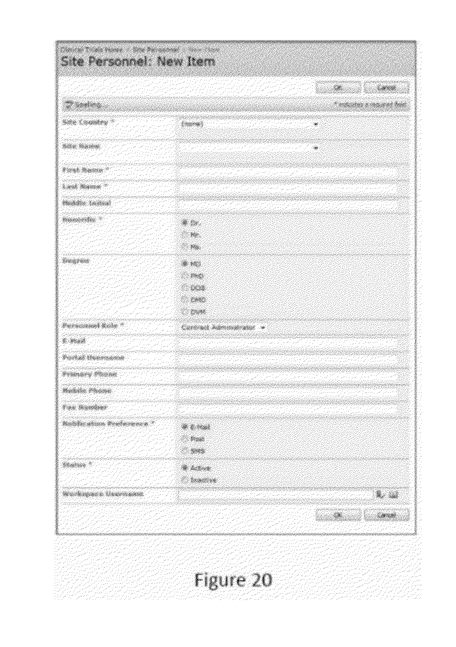

FIGS. 18-24 illustrate exemplary embodiments of the forms used to manage the clinical trial data stored in the SharePoint lists. The forms in FIGS. 18-20 use standard SharePoint list processing. To create a new Clinical Trial list item in FIG. 18, the user clicks the “New” button on the “All Items” view. To edit an existing list item, the user clicks on the “Edit” icon that is linked to the list item on the “All items” view. To create a new Investigational Site list item in FIG. 19, the user clicks the “New” button on the “All Items” view. To edit an existing list item, the user clicks on the “Edit” icon that is linked to the list item on the “All items” view. To create a new Site Personnel list item in FIG. 20, the user clicks the “New” button on the “All Items” view. To edit an existing list item, the user clicks on the “Edit” icon that is linked to the list item on the “All items” view. On the other hand, the form in FIG. 21 is implemented as a custom server-generated web page based on ActiveX scripting that uses the Microsoft ASP.NET framework. The form in FIG. 21 is only available at the clinical trial sub-site and is used to build the Investigational Site list at that sub-site. The form is initially loaded with the contents of the Investigational Site list. The list can be filtered using the country drop-down to restrict the number of items displayed on the form. If the user clicks on an individual Site Name, the “Edit Form” for that list item will open. If the user clicks the “Create new site” link, the “New Item” form for the list will open. If the user selects the “Add from existing sites” link, the “Add from Existing Sites” sub-form will open.

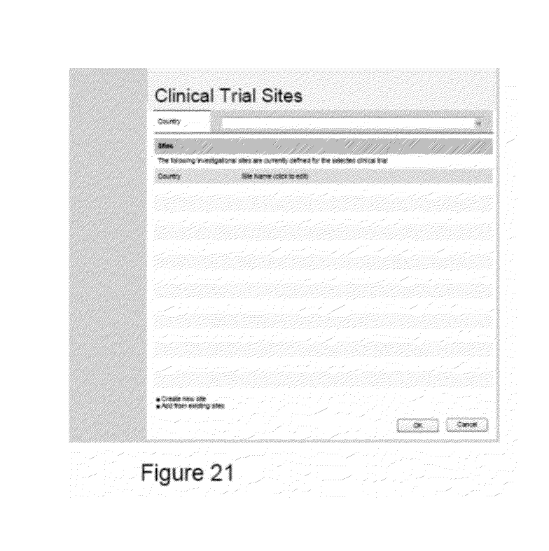

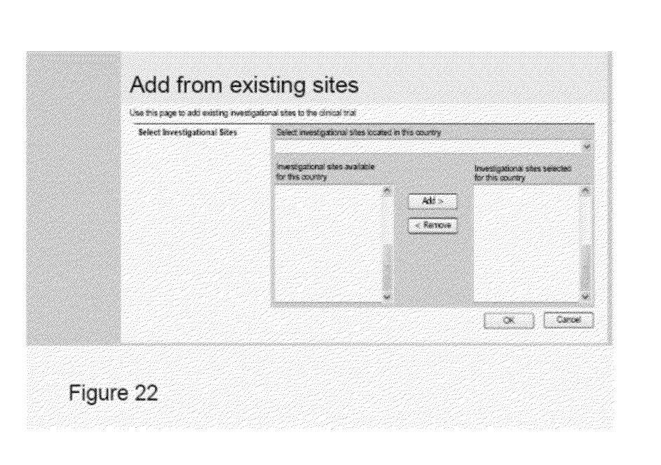

The forms in FIGS. 22-24 are implemented as a custom server-generated web page based on ActiveX scripting that uses the Microsoft ASP.NET framework. The form of FIG. 22 is only available at the clinical trial sub-site and is used to build the Investigational Site list at that sub-site. The user must first select a country to filter the available investigational sites. The items that are displayed in the “Available” list box are those sites from the Investigational Site list located at the root site, that are in the selected country, have a status of “Active” and do not exist in the Investigational Site list located at the clinical trial sub-site. The items displayed in “Selected” list box are those sites from the Investigational Site list located at the clinical trial sub-site, are in the selected country and have a status of “Active”. The user may select one or more items from the “Available” list box and click the “Add” button to move them into the “Selected” list box. Likewise, the user may select one or more items from the “Selected” list box and click the “Remove” button to them into the “Available” list box. If an item is removed from the “Selected” list, its status is changed from “Active” to “Inactive” on the Investigational Site list located at the clinical trial sub-site. If an item is added to the “Selected” list box, a copy of the item is made from the Investigational Site list located at the root site and inserted into the Investigational Site list located at the clinical trial sub-site with a status of “Active”. Clicking the “OK” button commits the changes, while clicking the “Cancel” button abandons the operation.

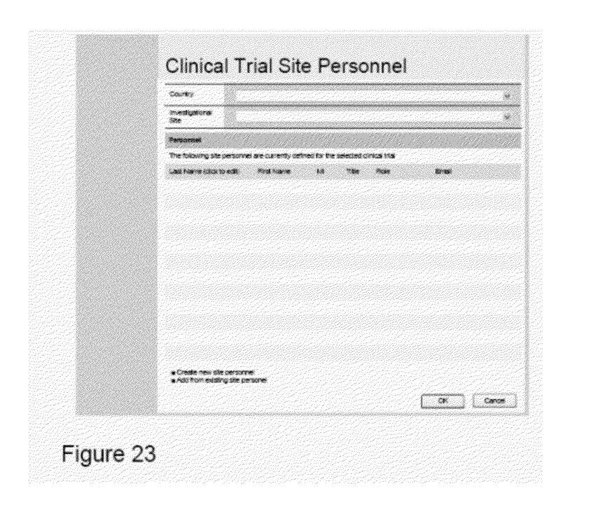

The form of FIG. 23 is only available at the clinical trial sub-site and is used to build the Site Personnel list at that sub-site. The form is initially loaded with the contents of the Site Personnel list. The list can be filtered using the country and investigational site drop-downs to restrict the number of items displayed on the form. If the user clicks on an individual Last Name, the “Edit Form” for that list item will open. If the clicks the “Create new site personnel” link, the “New Item” form for the list will open. If the user selects the “Add from existing site personnel” link, the “Add from Existing Site Personnel” sub-form will open.

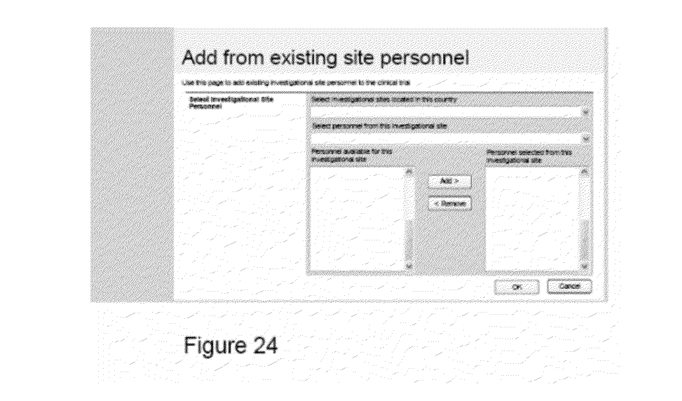

The form of FIG. 24 is only available at the clinical trial sub-site and is used to build the Site Personnel list at that sub-site. The user must first select a country to filter the available investigational sites. The user must then select an investigational site to filter the available sites personnel. The items that are displayed in the “Available” list box are the site personnel from the Site Personnel list located at the root site, that are in the selected investigational site, have a status of “Active” and do not exist in the Site Personnel list located at the clinical trial sub-site. The items displayed in “Selected” list box are those sites from the Site Personnel list located at the clinical trial sub-site, are in the selected investigational site and have a status of “Active”. The user may select one or more items from the “Available” list box and click the “Add” button to move them into the “Selected” list box. Likewise, the user may select one or more items from the “Selected” list box and click the “Remove” button to them into the “Available” list box. If an item is removed from the “Selected” list, its status is changed from “Active” to “Inactive” on the Site Personnel list located at the clinical trial sub-site. If an item is added to the “Selected” list box, a copy of the item is made from the Site Personnel list located at the root site and inserted into the Site Personnel list located at the clinical trial sub-site with a status of “Active”. Clicking the “OK” button commits the changes, while clicking the “Cancel” button abandons the operation.

### Secure Extranet Access

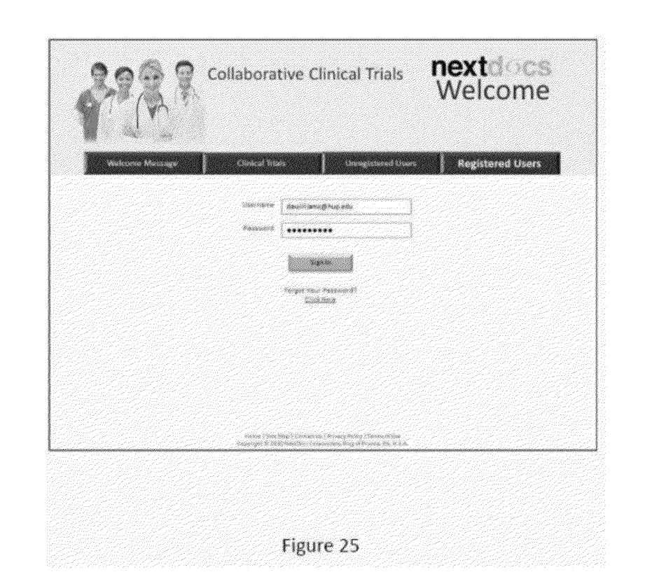

FIGS. 25-27 describe an exemplary embodiment of the Secure Extranet Access for the system illustrated in FIGS. 1 and 2. Secure Extranet Access is a site collection feature that provides components that enhance forms based authentication (FBA) extranet access to a SharePoint site. Once a SharePoint site has been configured for FBA extranet access, the feature provides the following functionality:

1. User self-registration: An external user can register for a login account. Registration information is collected and can be reviewed by a site collection administrator.

2. Password reminder: A registered external user can request an email containing login account information.

3. Account creation workflow activity: A custom Nintex workflow activity setting forth the sequence and order of the templates is provided that can be incorporated into a workflow for approving or rejecting an external user registration request. The custom activity is used to created user accounts in Active Directory (AD) of domain controller 171 (FIG. 2).

Secure Extranet Access may be used as follows. Suppose an unregistered external user enters the URL of a SharePoint site, configured for extranet access, in the browser. The user is presented with a login page that has a link to the self-registration page. The user follows the link to the registration page, enters the required registration information, and submits the registration request. The registration information is stored in a SharePoint list (FIG. 55) at the site collection root site. An approval workflow, manually created during extranet configuration, is started and the registration request is approved or rejected. If approved, a user account is created in the active directory store the supports the FBA extranet access, and an email containing login account information is sent to the external user.

The following is an exemplary presentation of the Extranet user list. When the Secure Extranet Access feature is activated, a listed named “Prospective Investigators” is created in the site collection root site. The list contains the requisite user registration information. Additionally, when items (registration requests) are added to this list an approval workflow can be configured to start.

| | Column | |
|---|---|---|
| Column Name | Type | Description |
| First Name | Text | The external user's first name |
| Last Name | Text | The external user's last name |
| Middle Name | Text | The external user's middle name |
| Email | Text | The external user's email address |
| Primary Facility | Text | The external user's primary |
| Name | | clinical facility |
| Street Address | Text | The external user's street address |
| City | Text | The external user's city |
| County | Lookup | The external user's country |
| State | Lookup | The external user's state |
| Postal Code | Text | The external user's postal code |
| Telephone | Text | The external user's telephone number |
| Number | | |
| Fax Number | Text | The external user's fax number |
| Medical License | Text | The external user's medical |
| | | license number |
| Medical License | Date | The date the external user's |
| Expiry | | medical license expires |
| Medical | Lookup | The external user's medical |
| Specialties | | specialties |
| Therapeutic Areas | Lookup | The external user's therapeutic |
| of Interest | | areas of interest |

FIG. 25 show the login page as seen by the external user. In this page the user is prompted for his User ID and Password.

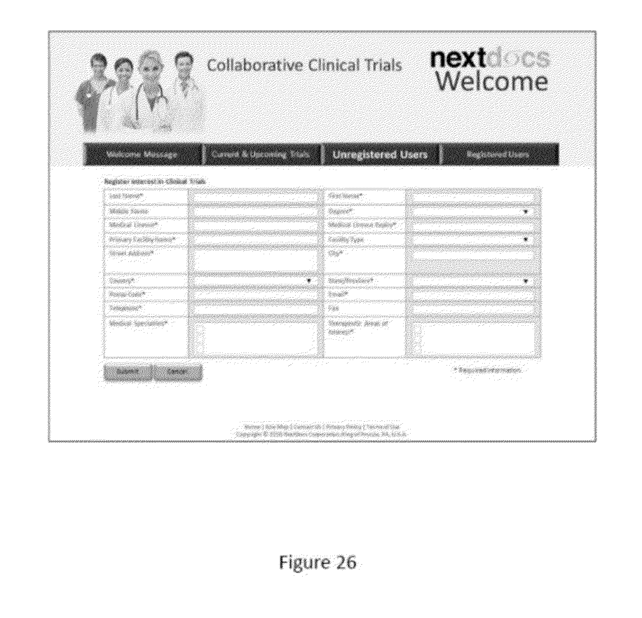

FIG. 26 shows the user registration page that is shown to an external user. The user is prompted for his First Name, Last Name, Email Address, Company Name, Phone Number, Address, City, Country, State, and Postal Code.

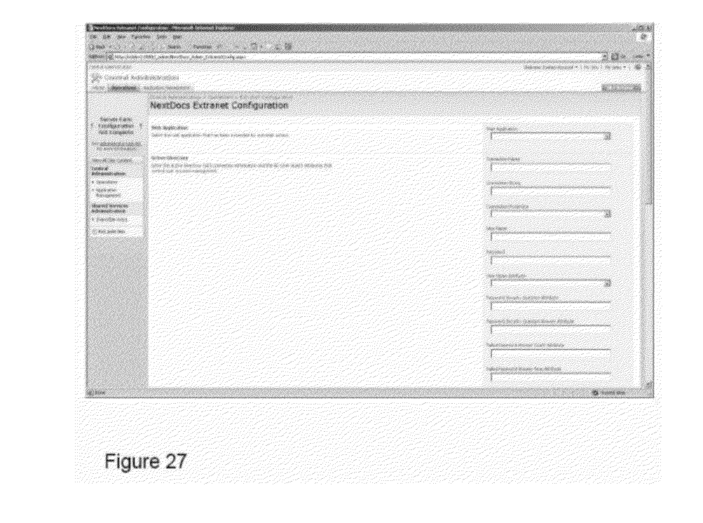

FIG. 27 shows the Central Administration site for configuring the Secure Extranet Access feature. The page is used to collect Active Directory information and SMTP information that is required by the components of the feature.

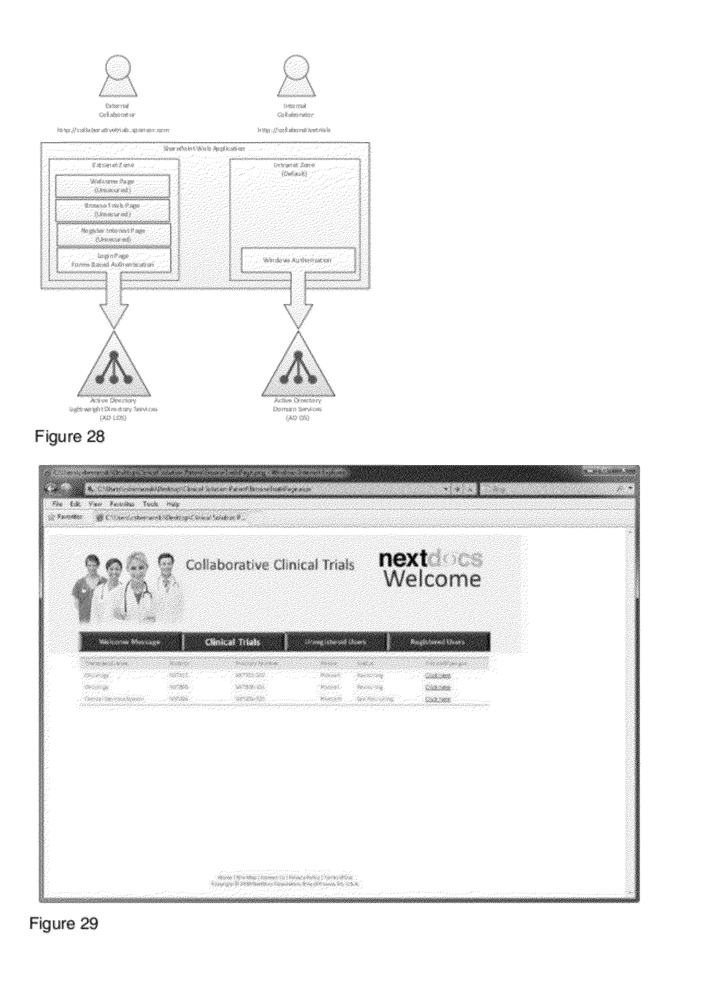

FIG. 28 shows the SharePoint Web application structure used by the collaboration portal in an exemplary embodiment. In this embodiment, a default web application is extended to include an “Extranet Zone” which exposes the same content in the web application to different types of users such as internal collaborators (the trial sponsor) and external collaborators (the investigators). When the web application is extended into a new zone, a separate Internet Information Services (IIS) web site is created to serve the same content, but with a unique Uniform Resource Locator (URL) and authentication type for validating a user's identity. As illustrated in FIG. 28, the Extranet Zone uses Microsoft Active Directory Lightweight Directory Services (AD LDS) to authenticate external users. After a user's identity is validated, the authorization process determines which clinical trial web sites, content, and other features the user can access.

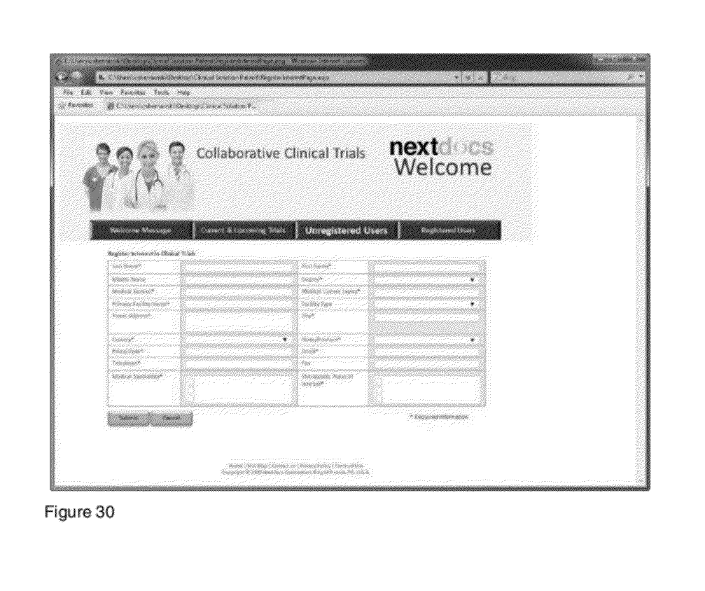

In FIG. 28, investigators and other external collaborators access the collaboration portal using an external URL, for example, http://collaborativetrials.sponsor.com. This URL directs the external user to the Extranet Zone of the web application. The Extranet Zone includes custom ASP.NET web pages to view the sponsor's welcome statement, browse the sponsor's clinical trials on a Clinical Trials page as illustrated in FIG. 29, and register their interest in participating in a clinical trial as illustrated in FIG. 30. Such web pages are unsecured and do not required authentication for access.

### External View

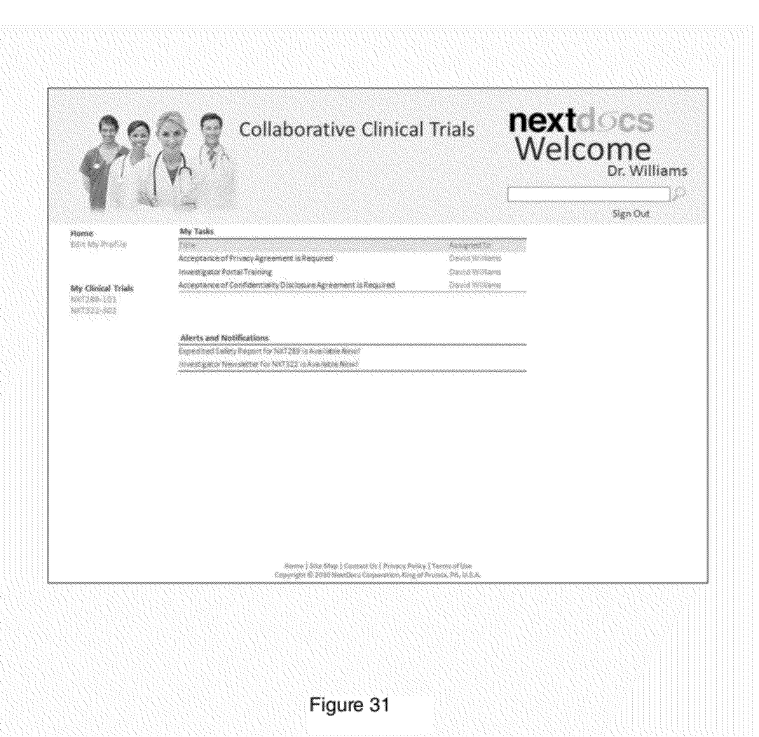

FIGS. 31-37 show the External view, which is a view into a SharePoint portal that exposes only those components necessary to support external participation in a SharePoint portal by individuals (e.g. clinical investigators) who are completing basic document exchange (i.e. upload and download), document review, document sign-off, and form fill-out tasks. External participants are defined as those with limited training in SharePoint-based systems and/or those with limited technology experience. From a role perspective, this includes Clinical Trial Investigators, Clinical Trial sub-Investigators, Labs, Internal Review Boards (IRBs), and other similar roles.

The External View covers the following key components of the portal:

1. Landing Page: SharePoint Portal “landing page” where external participants are redirected upon login.

2. To-do List: SharePoint Task List that has a list of tasks the participants must complete. A check-list of tasks may include one of the following “type” of actions:
a. Upload a new document (via the Smart Document Wizard);
b. Review a document, which may include:
   1. Downloading document;
   2. Editing on local computer;
   3. Uploading new version of document; and
   4. Completing task;
c. Sign a document; and
d. Fill-out a form for the case where a pre-existing document and/or InfoPath Form is available to be filled out.

3. Documents: A SharePoint document library for documents relevant to the portal visit. In other words, any documents relevant to support the document exchange, document review/approve and document sign-off tasks that must be completed.

4. Contact List (Optional): A SharePoint List that displays support contact information. This information is manageable in the page properties. This list is manageable in the “Edit Page” part.

5. Link List (Optional): A SharePoint List that contains useful links such as the training webcast, some documentation or links to other applications. This list is manageable in the “Edit Page” part.

6. Announcements (Optional): A SharePoint List that contains important announcements to be shared with visitors to the site.

7. Report (Optional): A graphical or other type of potential report to show high level summary of work completed and outstanding to-date for the external user.

8. My Clinical Trials: A list containing links to all of the clinical trial web-sites the user has access to. By default the current study is selected. When the user selects another study in the list, he/she is automatically directed to the clinical portal of that study. The drop down list is part of the master page, meaning that it is always available.

The user interface for the External View is designed be familiar and easy to use by anyone, and in particular persons who have limited training and/or experience with SharePoint-based systems. A variety of people will arrive at this page with varying degrees of technical experience; therefore, a focus on simplicity is a key to ensuring successful adoption and ease-of-use.

FIG. 31 shows the whole External View website. This website is composed of the following components:

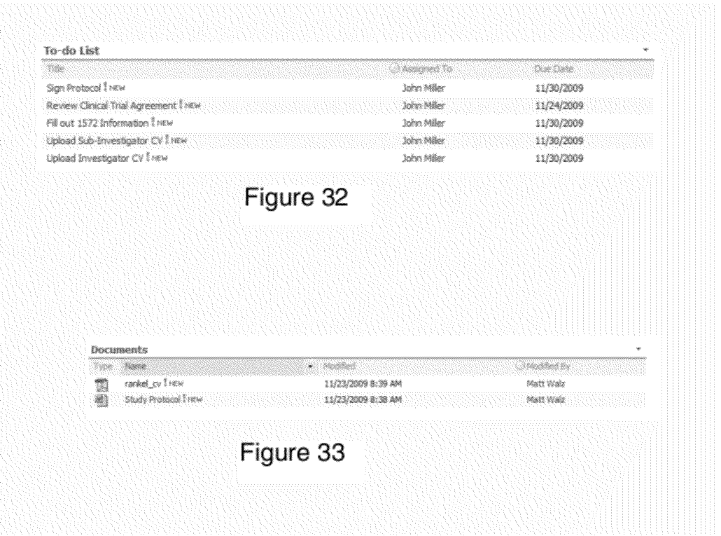

a sample to-do list (FIG. 32);

a sample document list (FIG. 33);

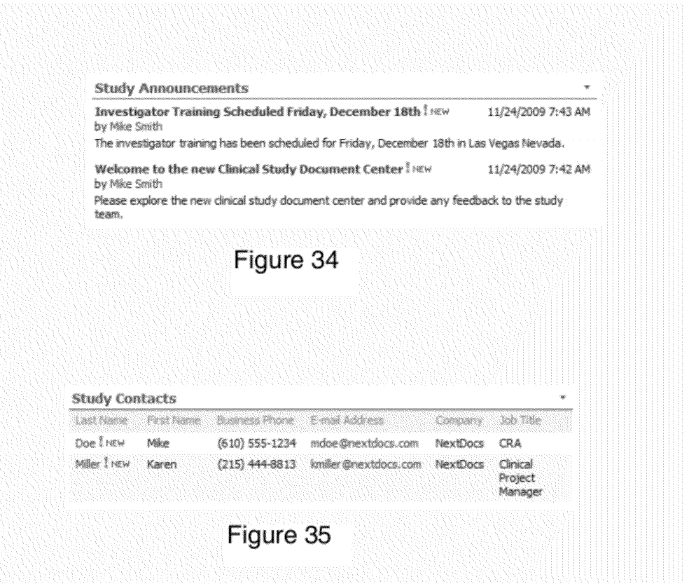

a sample of the study announcements (FIG. 34);

a sample of the study contacts (FIG. 35);

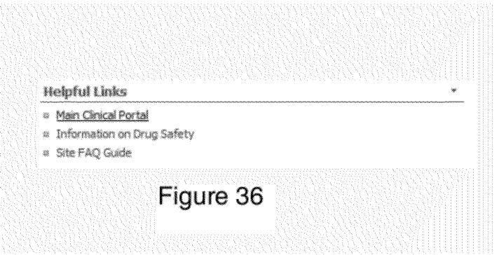

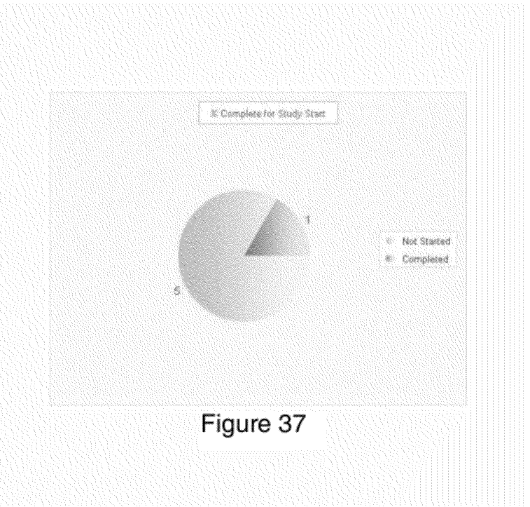

a sample of the study links (FIG. 36); and

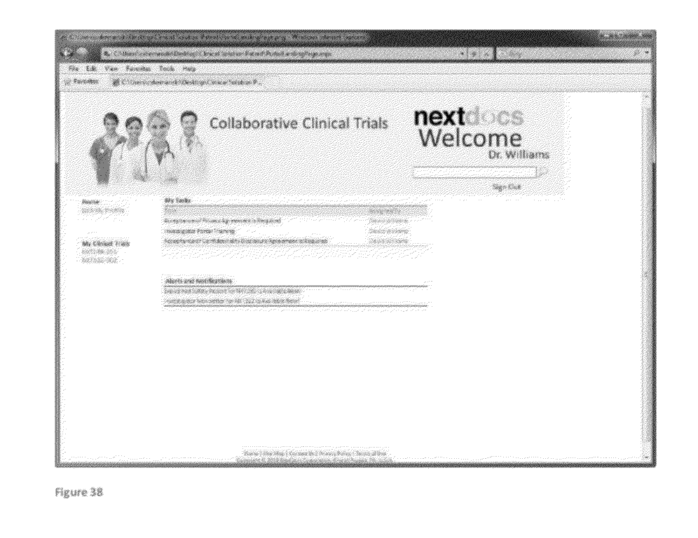

a sample of the study report (FIG. 37).

Typical use-case scenarios for the External View will be provided in the following examples.

### Example 1

### Authenticate a Landing Page

The procedure for the user to authenticate a landing page is the following:

1. A user types the URL in their browser to navigate to the External View landing page.

2. User is presented with authentication form where they will type in a username and password.

3. Once authenticated, the user will arrive at the External View landing page. On their landing page they will see a to-do list with the tasks they are required to complete as well as a list of documents relevant to their visit.

4. User may also see other optional components of information.

### Example 2

### Upload a Document

The procedure for the user to upload a document is the following:

1. [Complete Landing Page Story]

2. User clicks on the to-do list task entitled “Upload CV”.

3. The Site Document Upload web form is launched and fields are pre-populated with the metadata information to attach to the CV.

4. User clicks a “Browse” button and is presented with a document selector to navigate their local computer hard drive and select the appropriate document to upload.

5. User clicks “Okay” button.

6. Document is uploaded to the correct container/folder, metadata is properly attached, and task is completed.

7. User sees the document now appear in their “Documents” list.

### Example 3

### Review a Document

The procedure for the user to review a document is the following:

1. [Complete Landing Page Story]

2. User clicks on the to-do list task to “Review Clinical Trial Agreement”.

3. User is presented with a task screen with a text box to provide feedback and a link to the appropriate document.

4. User clicks link to open appropriate document.

5. Document is opened in a user's client document program (Adobe, MS Word, etc.).

6. User can review and make edits to document as appropriate. When finished, user closes document.

7. User may optionally choose to type text into task text box with their final comments.

8. User clicks okay and task is completed and removed from their to-do list.

### Example 4

### Sign a Document

The procedure for the user to sign a document is the following:
1. [Complete Landing Page Story]
2. User clicks on the to-do list task to “Sign Protocol”.
3. User is presented with a task screen with options to “Approve” or “Reject” the protocol. There is also a link to the protocol document to review prior to signing.
4. User clicks link to open appropriate document.
5. Document is opened in user's client document program (Adobe, MS Word, etc.).
6. User cannot make edits to document. When finished user closes document.
7. User Click “Approve” or “Reject” options on task screen.
8. If User clicks “Approve” they are presented with eSignature information (collection of password to eSign the document).
9. If User clicks “Reject” they are not presented with eSignature information.
10. After choosing “Approve” or “Reject” user clicks “OK” button.
11. Task is completed and removed from to-do list. If user selected to “Approve” the document, the document is eSigned by the user. This will log the signature information in the audit trail of the document as well as the version history. Signature information would also appear in the document.

### Example 5

### Fill Out a Form

The procedure for the user to fill out a form is the following:
1. [Complete Landing Page Story]
2. User clicks on to-do list task to “Fill out 1572”.
3. User is presented with a form (InfoPath, Adobe PDF, Word Form) user is to edit/fill-out. User can only edit defined fields in the form (text boxes, checkboxes, radio buttons, etc.) and not other portions of the form.
4. After completing, user clicks a “Save” or a “Submit” button (depending on how the form is designed). User's changes are saved back to the underlying system.
5. Form closes, task is marked completed and removed from their to-do list.

The contact information entered by an external user investigator on the Register Interest page shown in FIG. 30 is stored in a SharePoint list named Prospective Investigators. Data access between the Register Interest page and the Prospective Investigators list is controlled by an ASP.NET Business Object. A Nintex workflow automatically routes each new list item to a central administration group for identity and credential verification. If a list item is found to be erroneous, it is deleted from the Prospective Investigator list. Once an item is approved, the prospective investigator becomes eligible to participate in clinical trials.

The Extranet Zone also includes a custom ASP.NET web form that allows a registered external user to sign into the collaboration portal using ASP.NET Forms-Based Authentication (FBA). Once the external user is authenticated, he/she is required to perform the following actions before gaining full access to the collaboration portal: change their temporary password, accept the standard data privacy agreement, and verify their personal contact information. A Change Password page may also be provided as a custom ASP.NET web form that requires the external user to enter his/her existing password, and new password (governed by the password complexity rules defined in AD LDS). The user is required to re-type the new password to ensure accuracy. When the external user clicks the submit button on the Change Password page, their password is re-set using the AD LDS Application Programming Interface (API).

After re-setting their passwords, external users are redirected to a custom ASP.NET web page that prompts them to accept a standard data privacy agreement. The Privacy Agreement page retrieves and displays standard message text for the data privacy agreement. The external user can accept the terms of the agreement by clicking a button labeled “I Accept this Agreement” after which they are prompted to re-enter their username and password to verify their identity. The date and time corresponding to the acceptance of the agreement is recorded in the Facility Personnel list via an ASP.NET Business Object. If the external user declines the terms of the agreement by clicking a button labeled “I Reject this Agreement,” an email message is sent to the central administration group with instructions to personally follow-up with the user. Once the external user accepts the data privacy agreement, he/she is directed past this page in subsequent visits to the collaboration portal. The final action required by the external user prior to gaining access to the collaboration portal is the verification and confirmation of their contact information—this is called their personal profile. The Confirm Personal Profile page is a custom ASP.NET web form that is used to manage information that is stored in the Clinical Personnel SharePoint list.

External users may modify their profile information and submit their changes by clicking on the button labeled “Submit.” Data access between the Confirm Personal Profile page and the Clinical Personnel list is controlled by an ASP.NET Business Object. The completion of this action is recorded in the Clinical Personnel list. External users are prevented from accessing the collaboration portal until this task is completed and will continually be directed to the web page until they do so. Once the external user confirms their personal profile, he/she is directed past this page in subsequent visits to the collaboration portal.

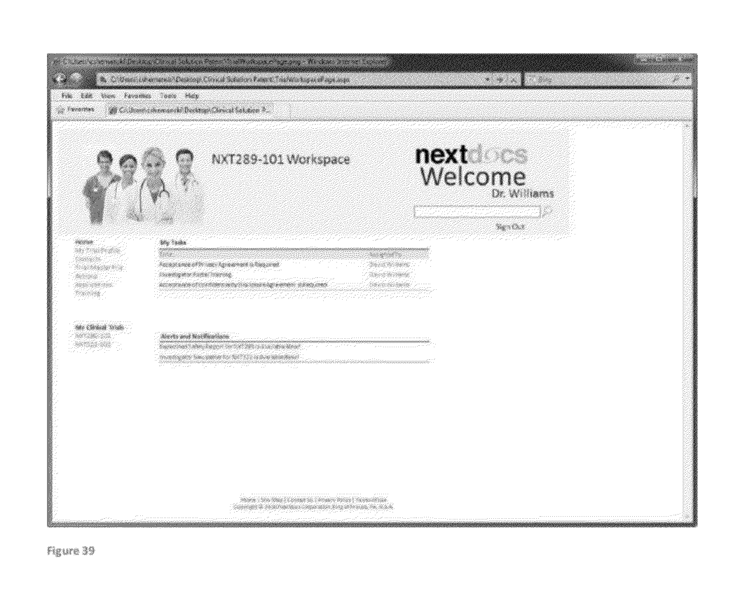

After completing the required actions, the external user is directed to the landing page of the collaboration portal as illustrated in FIG. 38. From this page, the external user is presented with their “To-Do List”—an inventory of work items that they must complete across all of the clinical trials they are participating in. They are also presented with a list of “Alerts and Notifications” which informs them of important events that have occurred or are going to occur across all of the trials they are participating in. The external user is also presented with an option to edit their personal profile.

Clicking on the Edit My Profile link (FIG. 38) directs the external user to an Edit Personal Profile page, which is a custom ASP.NET web form used to manage information in the Clinical Personnel list in SharePoint. External users modify their profile information and submit their changes by clicking on the button labeled “Submit”. Data access between the Edit Personal Profile page and the Clinical Personnel list is controlled by an ASP.NET Business Object. External users can cancel the operation and return to the collaboration portal landing page by clicking on the button labeled “Cancel”.

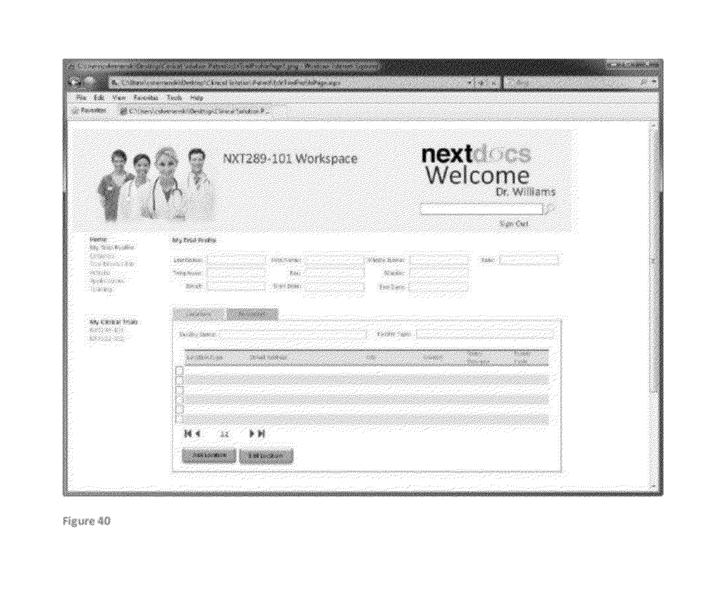

External users are presented with a list of clinical trial web site URLs (called workspaces) that they have been invited to participate in. These URLs appear under the “My Clinical Trials” heading (FIG. 38). Clicking on a workspace URL directs the external user to the landing page of a specific clinical trial (FIG. 39). The clinical trial workspace landing page presents the external user with his/her “To-Do List” of work items that they must complete for the specific clinical trial. The user is also presented with a list of “Alerts and Notifications” which informs him/her of important events that have occurred or are going to occur for the specific trial.

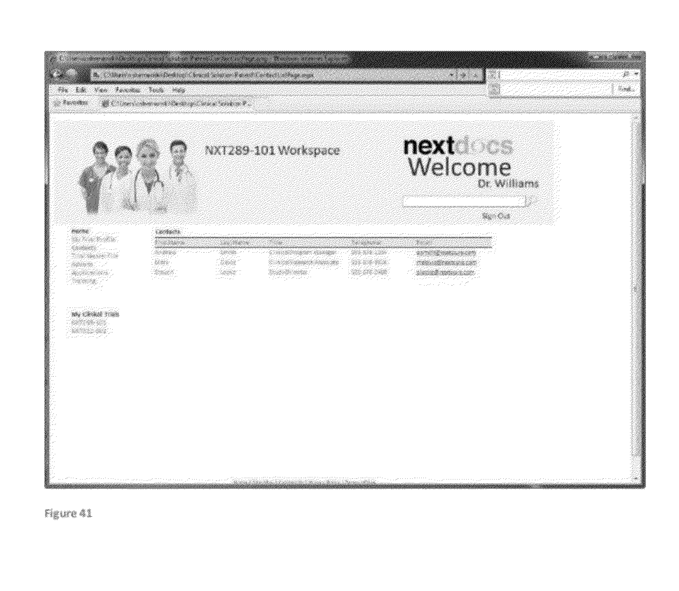

The external user also has the ability to define and maintain his/her trial-specific profile by clicking on the “My Trial Profile” URL which directs him/her to the “My Trial Profile” page (FIG. 40), which is a custom ASP.Net web form that is used to manage information that is stored in the Clinical Facility, Clinical Personnel, Clinical Facility Locations, Clinical Trial Site, Clinical Trial Site Personnel and Clinical Trial Site Location SharePoint lists. The “My Trial Profile” page of FIG. 40 allows external users to maintain trial specific addresses (locations) for their facility. The external user can add new locations by clicking the button labeled “Add Location” or can modify existing locations by selecting an item from the list of displayed locations and clicking the button labeled “Edit Location”. In both cases, the Add/Edit Location sub form is displayed. The Add/Edit Location sub form updates information stored in the Clinical Facility Locations and Clinical Trial Site Locations SharePoint lists using ASP.NET Business Objects.

The external user can manage clinical trial personnel by clicking on the “Personnel” tab of the “My Trial Profile” page. He/she can add new personnel by clicking the button labeled “Add Personnel” or can modify existing personnel by selecting an item from the list of displayed personnel and clicking the button labeled “Edit Personnel”. In both cases the Add/Edit Personnel sub form is displayed. The Add/Edit Location sub form updates information stored in the Clinical Personnel and Clinical Trial Site Personnel SharePoint lists using ASP.NET Business Objects.

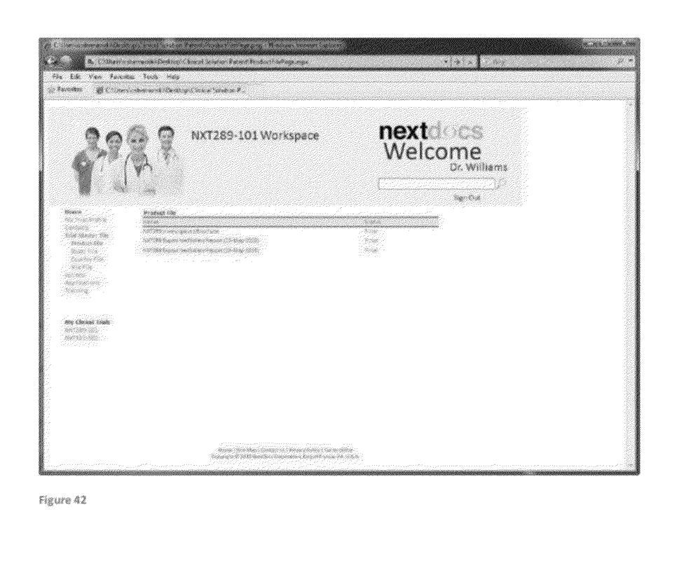

The external user also has the ability to view his/her “Contact List” by clicking on the Contact List URL. This action directs him/her to the Contact List web page (FIG. 41), which displays information about the personnel from the sponsor organization that he/she must interact with during the conduct of the clinical trial. The sponsor personnel information displayed on the page is limited to only those sponsor personnel that are directly associated with the facility the external user is associated with. This filtering is implemented using a custom developed SharePoint Webpart that interacts with an ASP.Net Business Object to retrieve the appropriate contact data.

The external user has the ability to view the electronic trial master file by clicking on the Trial Master File URL. The Trial Master File includes four distinct SharePoint document libraries:

i. Product File—Documents that are applicable to the products under investigation;

ii. Study File—Documents that are applicable to the entire clinical trial;

iii. Country File—Documents that are applicable to a specific country in which the clinical trial is being conducted; and

iv. Site File—Documents that are applicable to a specific investigational site at which the clinical trial is being conducted.

The external user can navigate directly to each document library by clicking on the appropriate URL. External users are only able to access documents that meet the following criteria:

i. Product File—Documents classified as public documents;

ii. Study File—Documents classified as public documents;

iii. Country File—Document classified as public documents that are applicable to the country in which the external user's facility is located; and

iv. Site File—Document classified as public documents that are applicable to the facility the external user is associated with.

Access to the documents for external users is controlled by a custom HTTP (Hyper Text Transport Protocol) module that compares user credentials with metadata associated with each document and determines whether or not the user can access the document. Documents that are not accessible are removed from the external user's view of the document libraries. This is accomplished using a custom SharePoint Webpart that interacts with an ASP.Net Business Object to retrieve the appropriate documents. The design of such modules are well known to those skilled in the art and will not be described here.

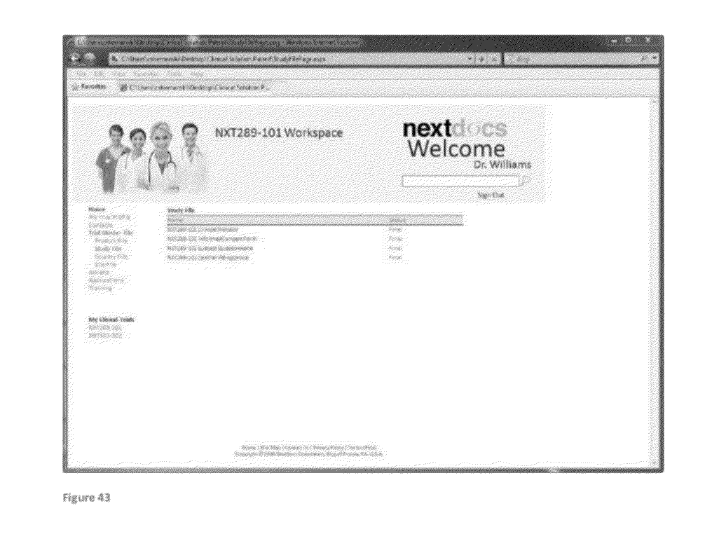

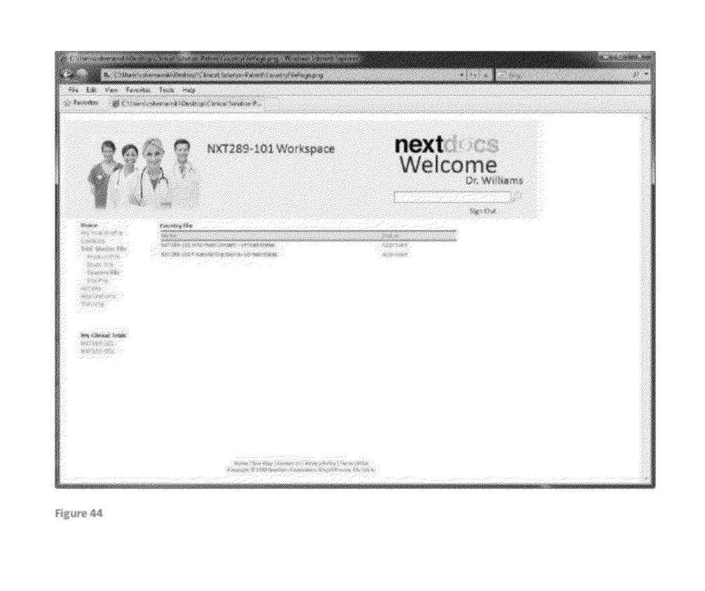

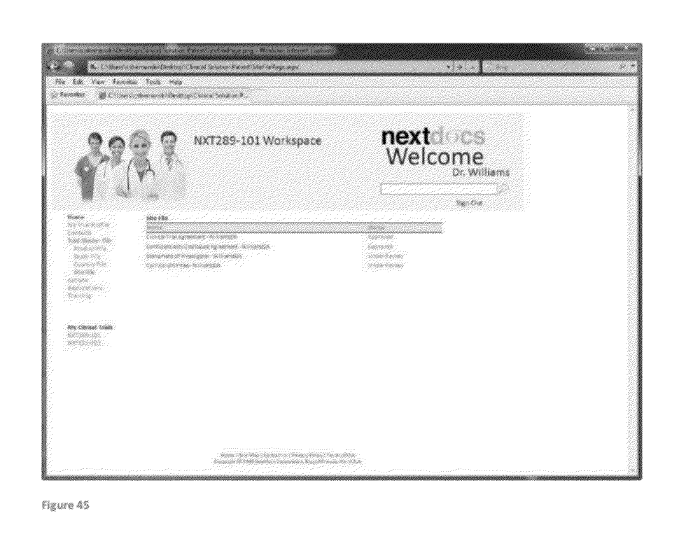

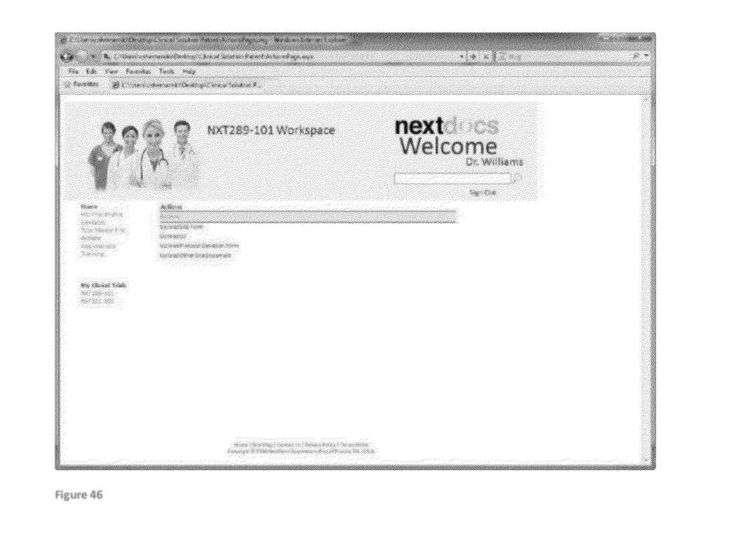

Exemplary Trial Master File pages are illustrated in FIGS. 42 through 45, respectively, where FIG. 42 illustrates the Product File; FIG. 43 illustrates the Study File; FIG. 44 illustrates the Country File; and FIG. 45 illustrates the Site File.

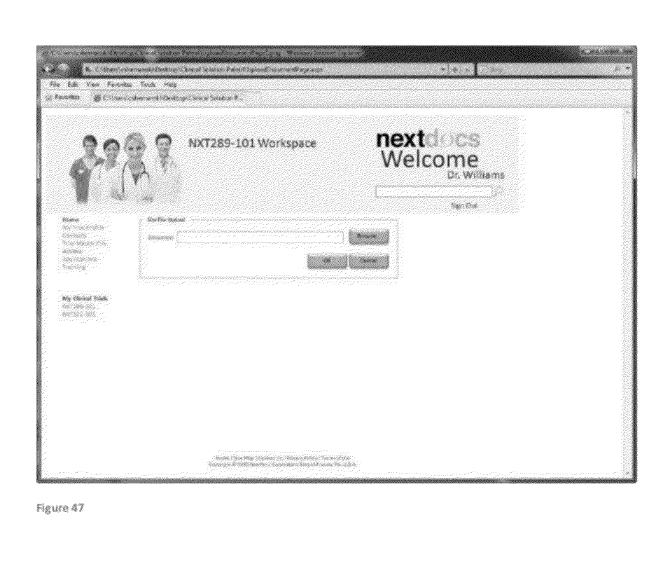

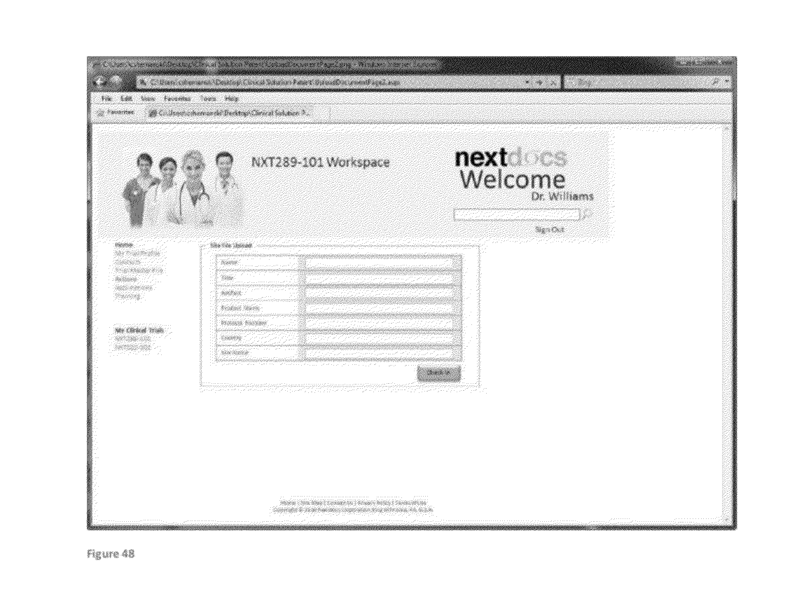

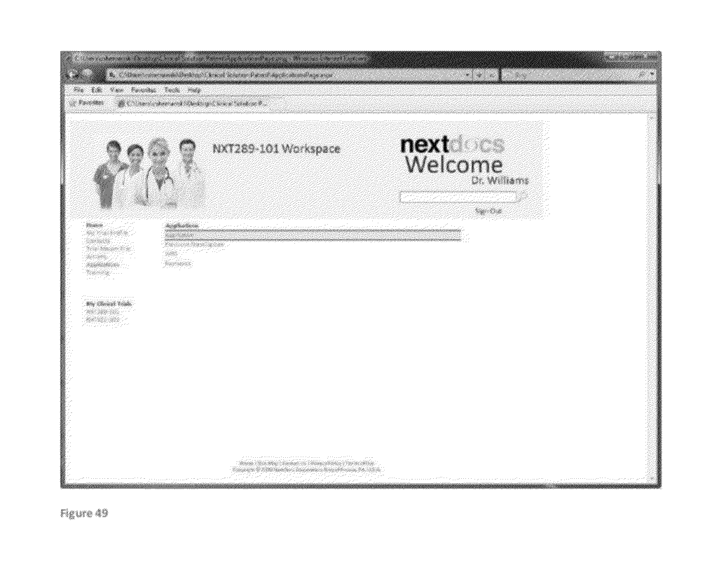

The external user can upload documents into the Site File by clicking on the Actions URL. The user is presented with a list of predefined documents to upload, or he/she is given the option to upload a document that is not on the list (FIG. 46). If the external user clicks on one of the predefined documents (for example “Upload CV”), he/she is directed to the Upload Site Document page (FIG. 47). The Upload Site Document page is a custom ASP.NET web form that allows an external user to browse and select the file he/she intends to upload. When the external user clicks the button labeled “OK,” he/she is directed to a subsequent Upload Site Document web form (FIG. 48) where he/she must identify the document by entering the name and title of the document and clicking the button labeled “Check-In”. In the case where the external user selected a predefined document, the “artifact” field is automatically pre-populated and cannot be modified. In the case where the external user selected a generic document, he/she selects a value for the artifact field from a drop-down list. Based on the artifact field, the document is automatically filed in the proper folder structure within the Site File. If the folder structure does not exist, it is automatically created prior to the document being uploaded. The interaction between the Upload Site Document page and the SharePoint document library is managed by custom SharePoint API calls.

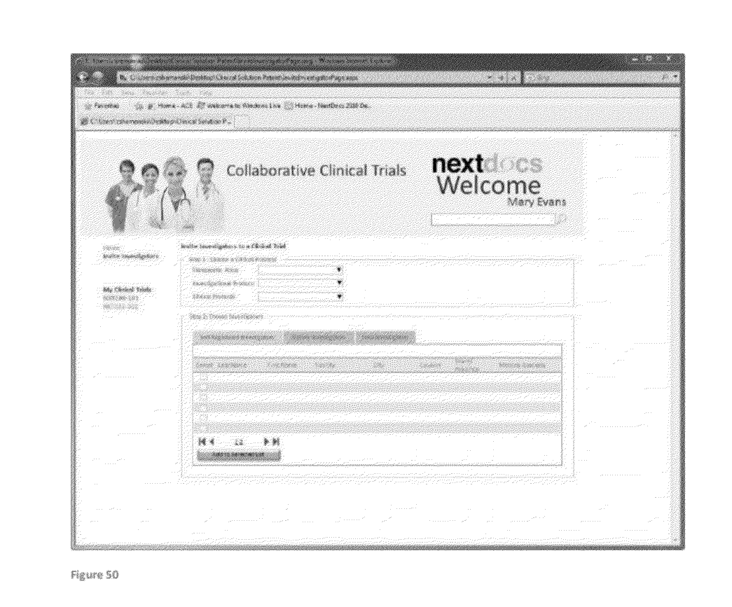

The external user can access other web-based clinical trial applications by clicking on the Applications URL. The user is presented with a list of application URLs that will direct him/her to those systems. This page is illustrated in FIG. 49. Similarly, the external user can access a library of training artifacts by clicking on the Training URL. The user is presented with a list of training items, such as the User Guide, Frequently Asked Questions (FAQs) and Instructional Videos which they can reference as needed.

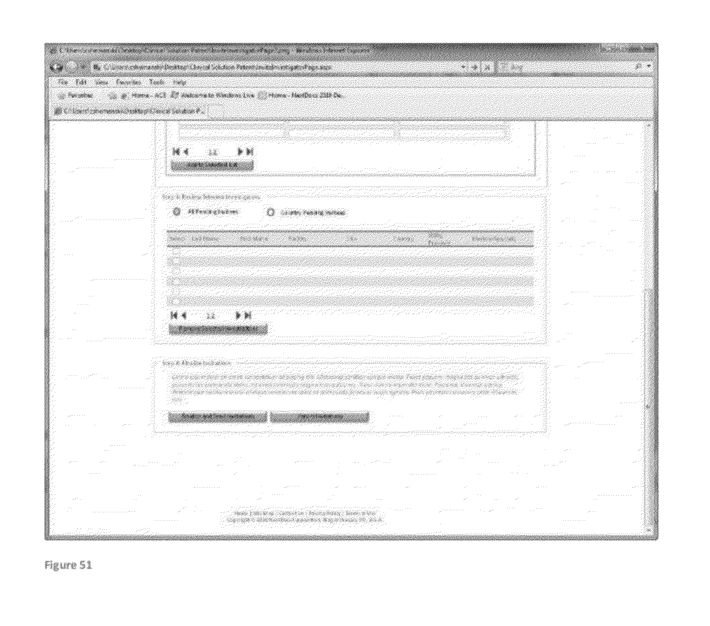

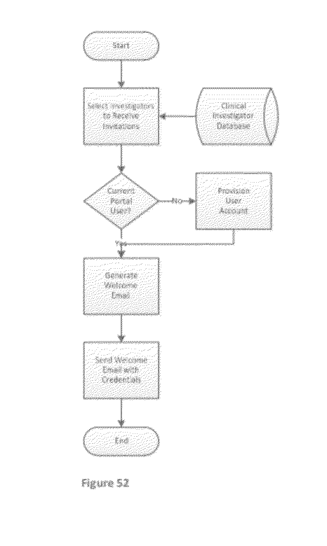

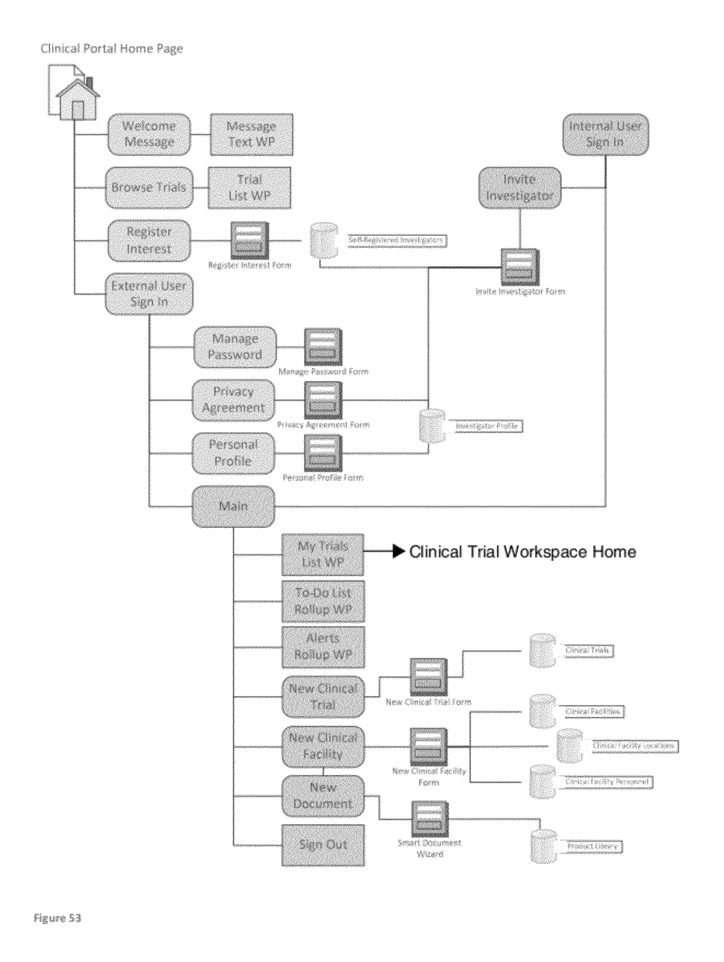

Sponsor personnel access the Intranet Zone of the collaboration portal using their web browser. Specific personnel (called study managers) within the trial sponsor organization are responsible for recruiting clinical investigators to participate in clinical trials. The study manager can invite one or more clinical investigators to participate in a trial using an invite investigator page. The invite investigator page is implemented as custom ASP.NET web form. Using the invite investigator page, the study manager may browse the prospective investigator list (FIG. 50) or a similar known investigator list to identify clinical investigators that possess the attributes needed for a specific clinical trial. These attributes include (but are not limited to) geographic location and medical specialty. The study manager may also invite an investigator that is neither in the prospective investigator list nor the known investigator list by entering their first name, last name and email address into the web form. The study manager adds investigators to the invitees list by selecting an investigator and clicking the button labeled “Add to Selected List”. The invitee list is persistent so the study manager can build it over a period of time. The study manager can remove previously selected investigators from the invitee list by clicking the button labeled “Remove Selected Investigators” (FIG. 51). The study manager can elect to filter the invitee list to display all invited investigators or only invited investigators located in the country they are responsible for by selecting the associated radio button. Once the study manager is satisfied with the invitee list, he/she can initiate the invitation process by clicking on the button labeled “Finalize and Send Invitations” or he/she can remove all pending invitations by clicking the button labeled “Cancel Invitations” (FIG. 51). When investigators are invited, they are added to the provisioning queue. If the invited investigator has not participated in trials previously (i.e. was selected from the prospective investigator list), a user account is automatically created and an email containing their username and temporary password is sent to them. This functionality is implemented via SharePoint timer job that polls the provisioning queue for new entries and takes action on those entries that have not been processed. Also, the prospective investigator's information is copied to the known investigator list and removed from the prospective investigator list. A welcome message containing a link to the Collaborative Clinical Trials website is sent to all invited investigators. This process is shown in FIG. 52.

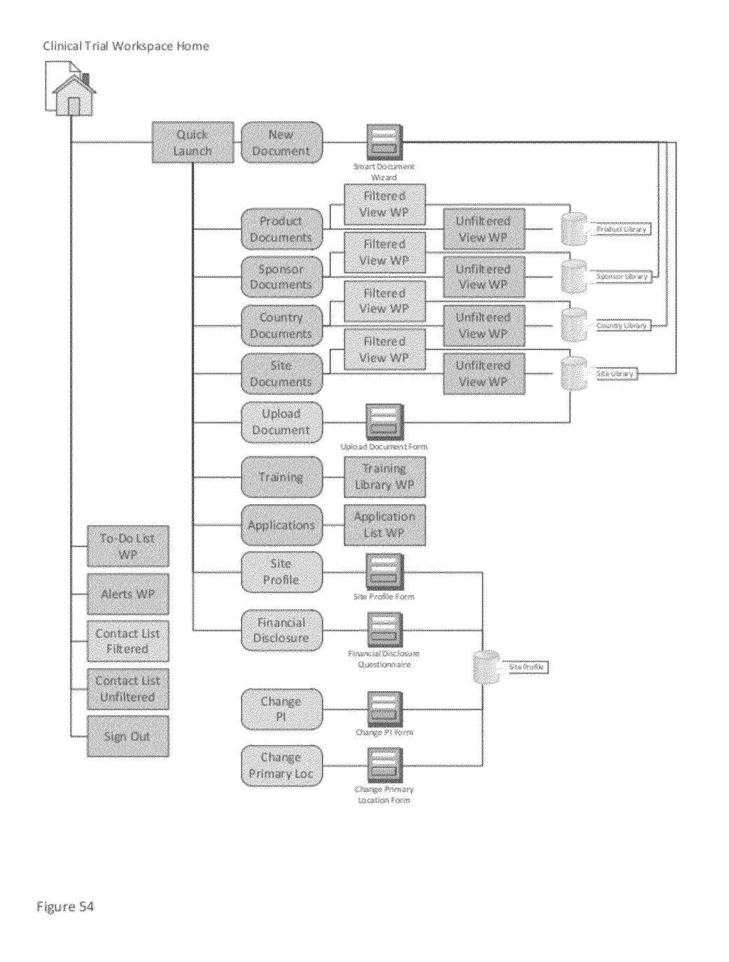

FIG. 53 shows the software layout of the clinical portal home page described above, and FIG. 54 shows the software layout of the clinical trial workspace home page described above. It will be appreciated by those skilled in the art that other forms may be added into this structure using the features of the content management software. FIG. 55 shows a representation of the logical data model for the key lists for the embodiment illustrated in FIGS. 53 and 54.

Those skilled in the art also will readily appreciate that many additional modifications and scenarios are possible in the exemplary embodiment without materially departing from the novel teachings and advantages of the invention. For example, the system is described for application using a SharePoint content management software system; however, those skilled in the art will appreciate that other content management software systems may be used to implement the functionality described herein. Accordingly, any such modifications are intended to be included within the scope of this invention as defined by the following exemplary claims.

What is claimed:

1. A method for administering clinical trials, comprising the steps of:
providing an administrator portal that enables a clinical trials administrator to create and manage at least one clinical trial website and to exchange clinical trial documents with said clinical trial website;
providing a clinical trial website for each clinical trial to be administered, each clinical trial website exchanging clinical trial documents with said administrator portal and each clinical trial web site having separate files for storing data supporting the associated clinical trial that is accessible by an administrator of the associated clinical trial and each authorized clinical investigator; and
providing an investigator portal for each clinical investigator, said investigator portal enabling the clinical investigator to upload documents related to a clinical trial to the separate files of the associated clinical trial website to which the investigator is authorized to participate, said investigator portal further enabling the investigator to monitor activities and communications related to the clinical trial to which the investigator is authorized to participate.

2. A method as in claim 1, the administrator portal further listing a plurality of investigators and enabling said administrator to communicate an invitation to an investigator inviting said investigator to participate in a clinical trial.

3. A method as in claim 1, the administrator portal further enabling the administrator to create a clinical trial master file, based on a template, for an associated clinical trial website for customization.

4. A method as in claim 1, the investigator portal further listing a plurality of clinical trials being administered by said administrator and enabling said investigator to communicate interest in participating in a particular clinical trial to said administrator.

5. A method as in claim 1, the investigator portal further enabling an investigator to define a personal profile for access by said administrator.

6. A method as in claim 1, the investigator portal further enabling an investigator to define a site profile for access by said administrator.

7. A method as in claim 1, the investigator portal further enabling the investigator to access product files relating to characteristics of the product being tested in the clinical trial.

8. A method as in claim 1, the investigator portal further enabling the investigator to index uploaded documents with identifying metadata.

9. A method as in claim 1, the investigator portal further enabling the investigator to access current versions of essential documents that govern the conduct of the clinical trial in real-time.

10. A method as in claim 1, the investigator portal communicating a to do list of required work items between said administrator and said investigator.

11. A method as in claim 1, the investigator portal communicating safety reports related to the products under investigation between said administrator and said investigator.

12. A system for administering clinical trials, comprising:
at least one processor and at least one memory storing instructions that when executed by said at least one processor cause said at least one processor to:
generate an administrator portal that enables a clinical trials administrator to create and manage at least one clinical trial website and to exchange clinical trial documents with said clinical trial website;
generate a clinical trial website for each clinical trial to be administered, each clinical trial website exchanging clinical trial documents with said administrator portal and each clinical trial web site having separate files for storing data supporting the associated clinical trial that is accessible by an administrator of the associated clinical trial and each authorized clinical investigator; and
generate an investigator portal for each clinical investigator, said investigator portal enabling the clinical investigator to upload documents related to a clinical trial to the separate files of the associated clinical trial website to which the investigator is authorized to participate, said investigator portal further enabling the investigator to monitor activities and communications related to the clinical trial to which the investigator is authorized to participate.

13. A system as in claim 12, wherein the administrator portal lists a plurality of investigators and enables said administrator to communicate an invitation to an investigator inviting said investigator to participate in a clinical trial.

14. A system as in claim 12, wherein the administrator portal enables the administrator to create a clinical trial master file, based on a template, for an associated clinical trial website for customization.

15. A system as in claim 12, wherein the investigator portal lists a plurality of clinical trials being administered by said administrator and enables said investigator to communicate interest in participating in a particular clinical trial to said administrator.

16. A system as in claim 12, wherein the investigator portal enables an investigator to define a personal profile for access by said administrator.

17. A system as in claim 12, wherein the investigator portal enables an investigator to define a site profile for access by said administrator.

18. A system as in claim 12, wherein the investigator portal enables the investigator to access product files relating to characteristics of the product being tested in the clinical trial.

19. A system as in claim 12, wherein the investigator portal enables the investigator to index uploaded documents with identifying metadata based on their identity and associated clinical trial and investigational site information.

20. A system as in claim 12, the investigator portal further enabling the investigator to access current versions of essential documents that govern the conduct of the clinical trial in real-time.

21. A system as in claim 12, wherein the communications include communications relating to a to do list of required work items that are communicated between said administrator and said investigator.

22. A system as in claim 12, the investigator portal communicating safety reports related to the products under investigation between said administrator and said investigator.

23. A system as in claim 12, wherein the processor further executes instructions of workflow management software that causes said generate steps to be implemented according to an order and sequence of a predetermined workflow driven by templates.
